(19) United States
(12) Patent Application Publication
(10) Pub. No.: US 2008/0137025 A1
(43) Pub. Date: Jun. 12, 2008

(54) Process for Producing Liquid Crystal Display Device, Spacer Particle Dispersion Liquid, and Liquid Crystal Display Device

(76) Inventor: Michihisa Ueda, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/794,165

(22) PCT Filed: Dec. 27, 2005
(86) PCT No.: PCT/JP05/23963

§ 371 Date: Sep. 4, 2007

(30) Foreign Application Priority Data
Dec. 27, 2004 (JP) 2004-377663
Dec. 27, 2004 (JP) 2004-377664
Feb. 4, 2005 (JP) 2005-029419

(51) Int. Cl. G02F 1/1339; G02F 1/1333

(52) U.S. Cl. 349/155; 445/24

(57) ABSTRACT

It is the object of the present invention to provide a method for producing a liquid crystal display device which comprises a step of arranging spacer particles on the surface of a substrate using an ink-jet device, and particularly to a method for producing a liquid crystal display device in which a spacer particle dispersion is improved.

The present invention is a method for producing a liquid crystal display device, having a pixel area and a non-pixel area, which comprises a step of arranging a spacer particle at a specific location corresponding to the non-pixel area by ejecting a spacer particle dispersion with a spacer particle dispersed, onto a surface of a first substrate or a second substrate using an ink-jet device, and a step of superimposing the first substrate on the second substrate via a liquid crystal and the spacer particle with the first substrate opposed to the second substrate, in the step of arranging the spacer particle, a liquid-contacting portion of an ink chamber receiving the spacer particle dispersion in a head of the ink-jet device comprising a hydrophilic material having a surface tension of 31 mN/m or more, and a surface tension of the spacer particle dispersion being 33 mN/m or more and being not more than a surface tension of the liquid-contacting portion plus 2 mN/m.

### TECHNICAL FIELD

The present invention relates to a method for producing a liquid crystal display device which comprises a step of arranging spacer particles on the surface of a substrate using an ink-jet device, and particularly to a method for producing a liquid crystal display device in which a spacer particle dispersion is improved, a spacer particle dispersion, and a liquid crystal display device.

### BACKGROUND ART

Currently, liquid crystal display devices are widely used to personal computers, portable electronics and the like.

FIG. 9 is a schematic front sectional view showing an example of a conventional liquid crystal display device. In this liquid crystal display device 200, two transparent substrates 201, 202 are located so as to be opposed to each other.

On the inner surface of the transparent substrate 201, color filters 203 and black matrixes 204 are formed. An overcoat layer 205 is formed on the color filters 203 and black matrixes 204. A transparent electrode 206 is formed on the overcoat layer 205. Further, an alignment layer 207 is formed so as to cover the transparent electrode 206. On the one hand, on the inner surface of the transparent substrate 202, a transparent electrode 208 is formed at the position opposed to the color filters 203. Further, an alignment layer 209 is formed so as to cover the inner surface of the transparent substrate 202 and the transparent electrode 208. On the other hand, on the outer surface of the transparent substrates 201, 202, polarizers 210, 211, respectively, are arranged. The transparent electrodes 206, 208 have pixel electrodes located at a pixel area and electrodes located at an area other than a pixel area.

The transparent substrate 201 and the transparent substrate 202 are bonded via a sealing material 212 to each other in the vicinity of the peripheries of the transparent substrates. Liquid crystals 214 are encapsulated in a space surrounded by the transparent substrate 201, 202 and the sealing material 212. Further, spacer particles 213 are arranged in the space. These spacer particles 213 perform so as to regulate a spacing of two transparent substrates 201, 202 and retain a proper thickness (cell gap) of a liquid crystal layer.

As a method of arranging spacer particles 213 in obtaining the liquid crystal display device 200, conventionally, a wet spray method of spraying the spacer particles using a solvent such as isopropanol and a dry spray method of spraying the spacer particles by making use of air pressure without using a solvent were employed.

In this method, since the spacer is sprayed on a substrate of a transparent substrate 201 uniformly at random, a spacer particle 213 tends to be arranged on a pixel electrode, that is, in a display area (pixel area) of a liquid crystal display device 200 as shown in FIG. 9. The spacer particle is generally formed from a synthesized resin or glass, and if the spacer particle is arranged on the pixel electrode, a spacer particle portion produces light leakage due to depolarization. In addition, when alignment of liquid crystal at the surface of the spacer particle is disturbed, light leakage occurs and contrast and color tone are deteriorated and display quality is deteriorated. On the other hand, in a TFT liquid crystal display device, a TFT device is located on a substrate. If the spacer particle is arranged on this TFT device, the element may be broken when a pressure is applied to the substrate.

In order to solve such a problem associated with random spray of the spacer particle, various attempts to arrange the spacer particle in a light-blocking area (non-pixel area) are tried.

As a method of arranging the spacer at only specific position, a method in which a mask having an opening is aligned with a desired position and then spacers are sprayed through the mask is disclosed in, for example, patent document 1. On the other hand, in patent document 2, a method in which spacers are electrostatically adsorbed on a photosensitive body and then the spacers are transferred to a transparent substrate is disclosed. Furthermore, in patent document 3, a method for producing a liquid crystal display device in which a voltage is applied to a pixel electrode on a substrate and charged spacers are sprayed and thereby the spacer is arranged at a specific position through an electrostatical repulsive force is disclosed.

However, in the methods described in patent document 1 and 2, since a mask or a photosensitive body comes into contact directly with the substrate, an alignment layer on a substrate is prone to damage. Accordingly, image quality of liquid crystal display tends to be deteriorated. On the other hand, in the method described in patent document 3, since an electrode according to a pattern arranged is required, it is impossible to arrange the spacer at arbitrary position.

On the other hand, in patent document 4, a method of arranging spacer particles using an ink-jet device is disclosed. In this method, spacers can be arranged in an arbitrary pattern at any location since the masks and the like do not come into contact with the substrate itself in contrast to the above case.

However, since spacer particles having a particle diameter of about 1 to 10 μm are contained in the spacer particle dispersion ejected, a nozzle diameter of an ink-jet head needs to be enlarged to eject straight. Consequently, a droplet ejected onto a substrate becomes large and goes over from a light-blocking area into a pixel area even though the droplet is ejected aiming for the light-blocking area which is not a pixel area, and therefore some spacers are arranged in the pixel area.

In order to solve such a problem, a method of enhancing the surface tension of the spacer particle dispersion and decreasing the size of the droplet ejected onto the substrate is conceivable. However, in a common ink-jet head, a liquid-contacting portion of a wall of an ink chamber is often covered with resin for insulating from parts to apply a voltage. Therefore, when the surface tension of the spacer particle dispersion is increased, since the surface tension of the liquid-contacting portion is low, the spacer particle dispersion has a low affinity for the liquid-contacting portion of a wall of an ink chamber and the spacer particle dispersion is often repelled. If the spacer particle dispersion has a low affinity and is repelled, air bubbles tends to remain in the ink chamber when the spacer particle dispersion is introduced into a head and ejected. If the air bubbles not drawn off remains, an ejecting pressure by a piezoelectric element may be absorbed in the air bubbles. Therefore, there may be cases where sufficient pressure for ejecting may not be attained and the droplet may not be ejected.

Further, the droplet ejected onto the substrate may be dried and contracted toward the center of deposition and some droplets are dried while keeping a diameter at the time when the droplet has deposited to the substrate and are not contracted toward the center. Accordingly, this method needed contrivance to contract the droplet toward the center and to gather the spacer in a light-blocking area.

However, the dispersion state of the spacer particles and the drying state of the spacer particle dispersion vary depending on the species of the solvent contained in the spacer particle dispersion, there might be cases where the spacer particles did not gather within the light-blocking area.

Moreover, some kinds of mediums may cause the viscosity of the spacer particle dispersion to decrease, and spacer particles might be settled in the spacer particle dispersion. Particularly, the spacer particle having a larger diameter tends to be settled. When the spacer particles are settled, the dispersion of spacer particles in the spacer particle dispersion becomes uneven. Therefore, when the spacer particle dispersion is ejected on a substrate, density variations of the spacer particles distributed on the substrate may occur. In order to prevent the spacer particle from settling, a method of ejecting the spacer particle dispersion while circulating the spacer particle dispersion within an ink-jet device is conceivable. However, in the case of ejecting the spacer particle dispersion with an ink-jet device, it was difficult to install such a circulation system. For example, if the spacer particle dispersion is circulated during ejection, the water head pressure of a nozzle face varies, and ejection accuracy was deteriorated or the spacer particle dispersion could not be ejected sometimes.

Further, in order to improve the display quality of a liquid crystal display device, the contamination of liquid crystal or an alignment layer have to be prevented. However, the spacer particle dispersion ejected onto the substrate may include impurities and the liquid crystal and the alignment layer were contaminated with impurities sometimes.

In addition, there might be cases where the dispersibility of the spacer particle in the spacer particle dispersion was poor or when the spacer particle dispersion includes impurities, it became hard to fix the spacer particle to the substrate in a drying process of a droplet ejected onto the substrate, and therefore the spacer particles were not arranged in a light-blocking area.

Thus, in conventional methods of producing a liquid crystal display device, the display quality such as color tone and contrast of a liquid crystal display device produced could not be adequately improved.

Patent document 1: Japanese Kokai Publication Hei-4-1913919

Patent document 2: Japanese Kokai Publication Hei-6-2583647

Patent document 3: Japanese Kokai Publication Hei-10-333878

Patent document 4: Japanese Kokai Publication Sho-57-58124

### DISCLOSURE OF THE INVENTION

### Problems to be Solved by the Invention

In view of the above-mentioned state of the art, it is an object of the present invention to provide a method for producing a liquid crystal display device, which can arrange a spacer particle at a location corresponding to a non-pixel area on a substrate using an ink-jet device, a spacer particle dispersion, and a liquid crystal display device.

### Means for Solving the Problems

The present inventors made intense investigations, and consequently found that by adjusting the surface tension of a spacer particle dispersion to a predetermined value with respect to the surface tension of a liquid-contacting portion of an ink chamber in a head of an ink-jet device, a spacer particle can be arranged at a location corresponding to a non-pixel area on a substrate using the ink-jet device, leading to completion of the first present invention.

That is, the method for producing a liquid crystal display device of the first present invention is a method for producing a liquid crystal display device, having a pixel area and a non-pixel area, which comprises a step of arranging a spacer particle at a specific location corresponding to the non-pixel area by ejecting a spacer particle dispersion with a spacer particle dispersed, onto a surface of a first substrate or a second substrate using an ink-jet device, and a step of superimposing the first substrate on the second substrate via a liquid crystal and the spacer particle with the first substrate opposed to the second substrate, in the step of arranging the spacer particle, a liquid-contacting portion of an ink chamber receiving the spacer particle dispersion in a head of the ink-jet device comprising a hydrophilic material having a surface tension of 31 mN/m or more, and a surface tension of the spacer particle dispersion being 33 mN/m or more and being not more than a surface tension of the liquid-contacting portion plus 2 mN/m.

A spacer particle dispersion used for such the method for producing a liquid crystal display device of the first present invention also constitutes the present invention.

In addition, the spacer particle dispersion of the first present invention is a spacer particle dispersion used when spacer particles are arranged on the surface of a substrate using an ink-jet device, and the surface tension thereof is 33 mN/m or more and is not more than the surface tension of the liquid-contacting portion of the ink chamber in the head of the ink-jet device plus 2 mN/m.

In addition, hereinafter, unless otherwise specified, the spacer particle dispersion used in the above method for producing a liquid crystal display device of the first present invention and the spacer particle dispersion of the first present invention are also collectively called a “spacer particle dispersion of the first present invention”.

The present inventors made intense investigations, and consequently found that by adjusting a receding contact angle (θr) to a substrate of the spacer particle dispersion and a water content to a predetermined value, a spacer particle can be arranged at a location corresponding to a non-pixel area on a substrate using the ink-jet device, leading to completion of the second present invention.

That is, the method for producing a liquid crystal display device of the second present invention is a method for producing a liquid crystal display device, having a pixel area and a non-pixel area, which comprises a step of arranging a spacer particle at a specific location corresponding to an area defining the pixel area by ejecting a spacer particle dispersion with a spacer particle dispersed, onto a surface of a first substrate or a second substrate using an ink-jet device, and a step of superimposing the first substrate on the second substrate via a liquid crystal and the spacer particle with the first substrate opposed to the second substrate, in the arranging the spacer particle at the specific location, a droplet of the spacer particle dispersion having a receding contact angle (θr) of 5 degree or more to the substrate and a water content contained in the spacer particle dispersion being 10% by weight or less.

A spacer particle dispersion used for such the method for producing a liquid crystal display device of the second present invention also constitutes the present invention.

Moreover, the spacer particle dispersion of the second present invention is a spacer particle dispersion used when spacer particles are arranged on the surface of a substrate using an ink-jet device, and a receding contact angle (θr) is 5 degree or more to the substrate and a water content of 10% by weight or less.

In addition, hereinafter, unless otherwise specified, the spacer particle dispersion used in the above method for producing a liquid crystal display device of the second present invention and the above-mentioned spacer particle dispersion of the second present invention are also collectively called a “spacer particle dispersion of the second present invention”.

Further, the present inventors made intense investigations, and consequently found that by adapting to cause little contamination of a liquid crystal if a liquid crystal is mixed in the spacer particle dispersion, a spacer particle can be arranged at a location corresponding to a non-pixel area on a substrate using the ink-jet device, leading to completion of the third present invention.

That is, the method for producing a liquid crystal display device of the third present invention is a method for producing a liquid crystal display device, having a pixel area and a non-pixel area, which comprises a step of arranging a spacer particle at a specific location corresponding to the non-pixel area by ejecting a spacer particle dispersion with a spacer particle dispersed, onto a surface of a first substrate or a second substrate using an ink-jet device, and a step of superimposing the first substrate on the second substrate via a liquid crystal and the spacer particle with the first substrate opposed to the second substrate, in the step of superimposing the first substrate on the second substrate via the liquid crystal and the spacer particle with the first substrate opposed to the second substrate, a rate of change of a volume resistivity of the liquid crystal being 1% or more and a change of a nematic-isotropic phase transition temperature of the liquid crystal being within ±1° C. from before to after arranging the liquid crystal.

A spacer particle dispersion used for such the method for producing a liquid crystal display device of the third present invention also constitutes the present invention.

And, the spacer particle dispersion of the third present invention is a spacer particle dispersion used when spacer particles are arranged on the surface of a substrate using an ink-jet device, and in the case of the spacer particle dispersion being mixed with a liquid crystal, the rate of change of a volume resistivity of the liquid crystal is 1% or more and a change of a nematic-isotropic phase transition temperature of the liquid crystal is within ±1° C.

In addition, hereinafter, unless otherwise specified, the spacer particle dispersion used in the above method for producing a liquid crystal display device of the third present invention and the above-mentioned spacer particle dispersion of the third present invention are also collectively called a “spacer particle dispersion of the third present invention”.

Moreover, the liquid crystal display device of the present invention is a liquid crystal display device, which is obtained by using the methods of producing a liquid crystal display device of the first, the second, or the third present invention, or the spacer particle dispersion of the first, the second, or the third present invention.

### EFFECTS OF THE INVENTION

In accordance with the method for producing a liquid crystal display device of the first present invention and the spacer particle dispersion used for the method for producing a liquid crystal display device, the liquid-contacting portion of the ink chamber, receiving the spacer particle dispersion, in the head of the ink-jet device to be used for ejecting the spacer particle dispersion comprises a hydrophilic material having a surface tension of 31 mN/m or more. Furthermore, the surface tension of the spacer particle dispersion is 33 mN/m or more and is not more than the surface tension of the liquid-contacting portion plus 2 mN/m. Accordingly, since a spacer particle dispersion having a high surface tension is used, a diameter of a droplet of the spacer particle dispersion having been deposited to the surface of the substrate becomes small and the arrangement accuracy of the spacer particle can be enhanced. Further, since the spacer particle dispersion has good affinity for the liquid-contacting portion of the ink chamber and is hardly repelled, air bubbles hardly remain within a nozzle when the spacer particle dispersion is introduced into a head and therefore the occurrence of an unejecting nozzle is inhibited.

Moreover, the spacer particle dispersion of the first present invention has the surface tension of 33 mN/m or more and of not more than the surface tension of the liquid-contacting portion of the ink chamber in the head of the ink-jet device plus 2 mN/m.

Accordingly, the spacer particle dispersion of the first present invention has a high surface tension, and a diameter of a droplet of the spacer particle dispersion of the first present invention having been deposited to the surface of the substrate becomes small and the arrangement accuracy of the spacer particle can be enhanced. Further, since the spacer particle dispersion has good affinity for the liquid-contacting portion of the ink chamber and is hardly repelled, air bubbles hardly remain within a nozzle when the spacer particle dispersion is introduced into a head and therefore the occurrence of an unejecting nozzle is inhibited.

Therefore, a liquid crystal display device constructed according to the first present invention does not cause light leakage due to spacer particles and has high display quality.

Furthermore, in accordance with the second present invention, since a droplet of the spacer particle dispersion has a receding contact angle (θr) of 5 degree or more to the substrate and a water content in the spacer particle dispersion is 10% by weight or less, spacer particles dispersed in the spacer particle dispersion are hardly settled with time, and therefore density variations of the spacer particles distributed on the substrate hardly occur. Accordingly, it is possible to arrange a spacer particle selectively with high accuracy at a specific location corresponding to the area defining the pixel area on the substrate.

Moreover, in accordance with the third present invention, since the rate of change of a volume resistivity of the liquid crystal is 1% or more and a change of a nematic-isotropic phase transition temperature of the liquid crystal is within ±1° C. from before to after arranging the liquid crystal, contaminations of the liquid crystal and the alignment layer are prevented. Therefore, deteriorations of display quality such as color tone and contrast of the liquid crystal display device hardly occur.

### BEST MODE FOR CARRYING OUT THE INVENTION

Hereinafter, the present invention will be described in detail. Further, in the descriptions below, when the contents are common to the first, the second, and the third present inventions and are not particularly differentiated among the first, the second, and the third present inventions, they will be simply described using an adjective phrase “of the present invention”.

FIG. 1 is a front sectional view showing schematically a liquid crystal display device obtained by a method for producing a liquid crystal display device of an embodiment of the present invention.

As shown in FIG. 1, in the liquid crystal display device 1, a first substrate 2 and a second substrate 3 comprising a transparent substrate are opposed to each other. As with the conventional crystal display device 200 shown in FIG. 9, on the inner surface of the first substrate 2, color filters 4 and black matrixes 5 are formed. An overcoat layer 6 is formed so as to cover the color filters 4 and the black matrixes 5. A transparent electrode 7 is formed on the overcoat layer 6. Moreover, an alignment layer 8 is formed so as to cover the transparent electrode 7.

On the other hand, on the inner surface of the second substrate 3, a transparent electrode 9 is formed at the position opposed to the color filters 4. An alignment layer 10 is formed so as to cover the transparent electrode 9.

Further, on the outer surface of the first substrate 2 and the second substrates 3, polarizers 11, 12, respectively, are laminated.

The first substrate 2 and the second substrate 3 are bonded via a sealing material 13 to each other in the vicinity of the peripheries of these substrates. Liquid crystals 15 are encapsulated in a space surrounded by the first substrate 2 and the second substrate 3. A plurality of spacer particles 14 are arranged at a location corresponding to a black matrix 6, i.e., a non-pixel area. Therefore, a spacing of the first and the second substrates 2, 3 are regulated by the spacer particles 14 and a proper thickness of a liquid crystal layer is retained.

### (Spacer Particle)

A material of the spacer particle used for the present invention is not particularly limited, and for example, both inorganic type particles such as silica particles and organic type articles such as organic polymers may be used. Among others, the organic type particles are preferably used since they have moderate hardness of not damaging an alignment layer formed on a substrate of a liquid crystal display device and is easy to follow the change in thickness due to thermal expansion or thermal contraction, and further has an advantage that a shift of spacer particles within a cell is relatively less.

The above-mentioned organic type particles are not particularly limited, but generally, a copolymer of a monofunctional monomer and a polyfunctional monomer is preferably used because of having the strength and the like within a proper range. In such a case, the ratio of the monofunctional monomer and the polyfunctional monomer is not particularly limited, and it is appropriately adjusted based on the strength or hardness required of organic particles to be obtained.

Examples of the above-mentioned monofunctional monomer include styrene derivatives such as styrene, α-methylstyrene, p-methylstyrene, p-chlorostyrene and chloromethylstyrene; vinyl esters such as vinyl chloride, vinyl acetate and vinyl propionate; unsaturated nitriles such as acrylonitrile; and (meth)acrylate derivatives such as methyl(meth)acrylate, ethyl(meth)acrylate, butyl(meth)acrylate, 2-ethylhexyl(meth)acrylate, stearyl(meth)acrylate, ethylene glycol(meth)acrylate, trifluoroethyl(meth)acrylate, pentafluoropropyl(meth)acrylate and cyclohexyl(meth)acrylate. These monofunctional monomers may be used alone or in combination of two or more species.

Examples of the above-mentioned polyfunctional monomer include divinylbenzene, 1,6-hexanediol di-(meth)acrylate, trimethylolpropane tri(meth)acrylate, tetramethylolmethane tri(meth)acrylate, tetramethylolpropane tetra(meth)acrylate, diallyl phthalate and isomer thereof, triallyl isocyanurate and derivatives thereof, trimethylolpropane tri(meth)acrylate and derivatives thereof, pentaerythritol tri(meth)acrylate, pentaerythritol tetra(meth)acrylate, dipentaerythritol hexa(meth)acrylate, polyethylene glycol di(meth)acrylate such as ethylene glycol di(meth)acrylate, polypropylene glycol di(meth)acrylate such as propylene glycol di(meth)acrylate, polytetramethylene glycol di(meth)acrylate, neopentyl glycol di(meth)acrylate, 1,3-butylene glycol di(meth)acrylate, 2,2-bis[4-(methacryloxypolyethoxy)phenyl]propane di(meth)acrylate such as 2,2-bis[4-(methacryloxyethoxy)phenyl]propane di(meth)acrylate, 2,2-hydrogenated bis[4-(acryloxypolyethoxy)phenyl]propane di(meth)acrylate, and 2,2-bis[4-(acryloxyethoxypolypropoxy)phenyl]propane di(meth)acrylate. These polyfunctional monomers may be used alone or may be used in combination of two or more species.

Furthermore, as the above-mentioned monofunctional or polyfunctional monomer, a monomer having a hydrophilic group may be used in order to enhance the dispersibility in ink. Examples of the above hydrophilic group include a hydroxyl group, a carboxyl group, a sulfonyl group, a phosphonyl group, an amino group, an amide group, an ether group, a thiol group and a thioether group.

Examples of a monomer having such a hydrophilic group include monomers having a hydroxyl group such as 2-hydroxyethyl(meth)acrylate, 1,4-hydroxybutyl(meth)acrylate, (poly)caprolactone modified hydroxyethyl(meth)acrylate, allyl alcohol, and glycerin allyl ether; acrylic acids such as (meth)acrylic acid, α-ethylacrylic acid and crotonic acid, and α-alkyl derivatives or β-alkyl derivatives thereof; unsaturated dicarboxylic acids such as fumaric acid, maleic acid, citraconic acid and itaconic acid; monomers having a carboxyl group such as mono 2-(meth)acryloyloxyethyl ester derivatives of these unsaturated dicarboxylic acids; monomers having a sulfonyl group such as t-butyl acrylamide sulfonic acid, styrenesulfonic acid and 2-acrylamido-2-methyl propane sulfonic acid; monomers having a phosphonyl group such as vinyl phosphate and 2-(meth)acryloyloxyethyl phosphate; compounds having an amino group such as amines having an acryloyl group, for example, dimethylaminoethyl methacrylate and diethylaminoethyl methacrylate; monomers having both a hydroxyl group and an ether group such as (poly)ethylene glycol(meth)acrylate and (poly)propylene glycol(meth)acrylate; monomers having an ether group such as terminal alkyl ether of (poly)ethylene glycol(meth)acrylate, terminal alkyl ether of (poly)propylene glycol(meth)acrylate and tetrahydrofurfuryl(meth)acrylate; and monomers having an amide group such as (meth)acrylamide, methylol(meth)acrylamide and vinylpyrrolidone.

A method for producing particles by polymerizing the above-mentioned monomer is not particularly limited and includes, for example, various polymerization methods such as suspension polymerization method, seed polymerization method, and dispersion polymerization method.

The above suspension polymerization method is suitably employed when a wide variety of particles having a desired particle size or particle size distribution are obtained by conducting a classification operation in the case of utilizing the obtained particles as a spacer particle since polydisperse particles having a relatively wide particle size distribution can be obtained. On the other hand, the above seed polymerization and dispersion polymerization are suitably employed when producing the particles having a specified particle diameter in large quantity since monodisperse particles can be obtained without conducting a classification operation.

The above-mentioned suspension polymerization method is a method, in which a monomer composition comprising a monomer and a initiator is dispersed in such a poor solvent that gives an intended particle diameter and polymerized. As a dispersion medium used for the above suspension polymerization, a substance obtained by adding a dispersion stabilizer to water is usually used. Examples of the above-mentioned dispersion stabilizer include polymers soluble in a dispersing medium, for example, polyvinyl alcohol, polyvinylpyrrolidone, methyl cellulose, ethyl cellulose, polyacrylic acid, polyacrylamide and poly(ethylene oxide). Furthermore, a nonionic or ionic surfactant is appropriately used. The conditions of polymerization vary with species of the above initiator and the above monomer, but usually, a polymerization temperature is 50 to 80° C. and a polymerization time is 3 to 24 hours.

The above-mentioned seed polymerization method is a polymerization method in which by allowing the monodisperse seed particle synthesized by soap-free polymerization or emulsion polymerization to absorb further a monomer, a diameter of the particle is expanded to a desired particle diameter. An organic monomer used in the above seed particle is not particularly limited and the above-mentioned monomer is used, but the composition of the above seed particle is preferably a monomer having compatibility with a monomer component in conducting seed polymerization in order to inhibit phase separation in the seed polymerization, and styrene and its derivatives are preferred from the viewpoint of monodispersibility of a particle size distribution.

A particle size distribution of the above seed particle is preferably as monodispersed as possible since this distribution is reflected on a particle size distribution after seed polymerization and CV value of the distribution is preferably 5% or less. Preferably, a monomer absorbed in the seed polymerization has a composition as close as possible to that of the seed particle since the phase separation between the monomer and the seed particle tends to occur in the seed polymerization as described above, and it is preferred that the seed particle absorbs an aromatic divinyl monomer when it is a styrenic monomer, and absorbs an acrylic polyfunctional vinyl monomer when it is an acrylic monomer to be polymerized with these absorbed monomers.

Further, in a seed polymerization method, the dispersion stabilizer can also be used as required. The above-mentioned dispersion stabilizer is not particularly limited as long as it is polymers soluble in a dispersion medium, and examples of the dispersion stabilizer include polyvinyl alcohol, polyvinylpyrrolidone, methyl cellulose, ethyl cellulose, polyacrylic acid, polyacrylamide and poly(ethylene oxide). Furthermore, a nonionic or ionic surfactant is appropriately used.

In the above seed polymerization method, it is preferred to add a monomer in an amount of 20 to 100 parts by weight with respect to 1 part by weight of the seed particle.

A medium used in the above-mentioned seed polymerization is not particularly limited and should be appropriately determined depending on a monomer to be used, but examples of generally suitable organic solvents include alcohols, cellosolves, ketones and hydrocarbons, and further these solvents may be used alone or may be used as a mixture of these organic solvents and other organic solvents or water, which is compatible with these organic solvents. Specific examples of the organic solvents include acetonitrile, N,N-dimethylformamide, dimethyl sulfoxide, ethyl acetate, alcohols such as methanol, ethanol, propanol; cellosolves such as methyl cellosolve, ethyl cellosolve; and ketones such as acetone, methyl ethyl ketone, methyl butyl ketone, 2-butanone.

The above-mentioned dispersion polymerization method is a method, in which by conducting polymerization in a poor solvent system which dissolves a monomer but does not dissolve a polymer produced and adding a polymer-based dispersion stabilizer to this system, the polymer produced is precipitated in the form of particle.

In addition, generally, when a crosslinked component is polymerized by the dispersion polymerization, the aggregation of the particles is apt to occur and it is difficult to obtain monodisperse crosslinked particles stably, but it becomes possible to polymerize a monomer containing the crosslinked component by selecting polymerization conditions.

In the polymerization, the above-mentioned polymerization initiator is used, and it is not particularly limited, but for example, organic peroxides such as benzoyl peroxide, lauroyl peroxide, o-chlorobenzoyl peroxide, o-methoxybenzoyl peroxide, 3,5,5-trimethylhexanoyl peroxide, t-butylperoxy-2-ethylhexanoate and di-t-butyl peroxide; and azo compounds such as azobis(isobutyronitrile), azobis(cyclohexacarbonitrile) and azobis(2,4-dimethylvaleronitrile) are suitably used. Further, an amount of the initiator to be used is preferably 0.1 to 10 parts by weight to 100 parts by weight of the monomer to be used in the polymerization.

A particle size of the spacer particle used in the present invention is not particularly limited because it can be appropriately selected based on the species of the liquid crystal display device, and a preferred lower limit of the above-mentioned particle size of the spacer particle is 1 μm and a preferred upper limit is 20 μm. When the particle size is less than 1 μm, the substrates opposed to each other may come into contact with each other and may not function adequately as a spacer of a liquid crystal display device, and when it is more than 20 μm, the spacer particle may tend to go over a light-blocking area and the like on which the spacer particles should be arranged on the substrate, and a distance between the opposed substrates becomes large and therefore the liquid crystal display device cannot adequately respond to the requests for downsizing and the like of a liquid crystal display device of recent years.

Since the spacer particle used in the present invention is used as a gap material for retaining a proper thickness of a liquid crystal layer, the spacer particle requires certain strength. When a measure of compressive strength of the particles is represented by compressive elastic modulus (a 10% K value) at 10% deformation of a particle diameter, 2000 to 15000 MPa is suitable in order to retain a proper thickness of a liquid crystal layer. When this compressive elastic modulus is less than 2000 MPa, the spacer may be deformed by press pressure in assembling the spacer particles into a display device and therefore it is difficult to secure a proper gap. When it is more than 15000 MPa, the spacer particle may damage the alignment layer on the substrate to cause display anomalies during incorporating it in a display device.

The above-mentioned compressive elastic modulus (a 10% K value) of the spacer particle is determined according to a method described in Japanese Kohyo Publication Hei-6-503180. For example, this value is determined from a load for deforming the particle by 10% with a flat end face of a diamond column of 50 μm in diameter by using Micro Compression Testing Machine (PCT-200, manufactured by SHIMADZU CORPORATION).

The spacer particle obtained by the above method may be colored to be used in order to improve contrast of a display device. Examples of the colored particle include particles treated with carbon black, disperse dye, acid dye, basic dye, metal oxide and the like; and particles in which an organic film is formed on the surface of the particle and this film is decomposed or carbonized at elevated temperatures to color the particle. Further, when a material itself forming the particle has a color, it may be used as is without coloring.

Moreover, a chargeable treatment may be applied to the spacer particle. The term chargeable treatment means to treat in such a way that the spacer particle has some potential even in the spacer particle dispersion and this potential (electric charge) can be measured by an existing method such as a zeta potentiometer.

Examples of a method of applying the chargeable treatment to the spacer particle include a method of containing a charge control agent in the spacer particle, a method for producing a spacer particle from a monomer containing a charge-prone monomer, and a method of applying a chargeable surface modification to the spacer particle.

Further, if the spacer particle is thus chargeable, the dispersibility and the dispersion stability of the spacer particle in the spacer particle dispersion is enhanced, and the spacer particles become easy to gather in the vicinity of a wiring (step) portion in spraying the spacer particles because of the electrophoretic effect.

Examples of the above-mentioned method of including a charge control agent in the spacer particle include a method in which the charge control agent is included in the spacer particle by performing the polymerization of the spacer particle in the presence of the charge control agent, a method in which the charge control agent is included in the spacer particle by copolymerizing a charge control agent having a functional group capable of copolymerizing with a monomer composing the spacer particle with the monomer composing the spacer particle in the polymerization of the spacer particle, a method in which in the surface modification of the spacer particle described later, the charge control agent is included in a surface modified layer by copolymerizing a charge control agent having a functional group capable of copolymerizing with a monomer to be used for the surface modification with the monomer to be used for the surface modification, and a method in which the charge control agent is included in the surface of the spacer particle by reacting a charge control agent having a functional group capable of reacting with a surface functional group of a surface modified layer or the spacer particle with the surface modified layer or the spacer particle.

The above-mentioned charge control agent is not particularly limited, and for example, a substance described in Japanese Kokai Publication 2002-148865 can be employed. Specific examples of the charge control agents include organometallic compounds, chelate compounds, monoazo dye metallic compounds, acetylacetone metallic compounds, aromatic hydroxycarboxylic acid, aromatic monocarboxylic acid and aromatic polycarboxylic acid and metal salt thereof, anhydride, esters, phenol derivatives such as bisphenol.

Further, the charge control agent is not particularly limited, and examples of the charge control agents include urea derivatives, metal-containing salicylic compounds, quaternary ammonium salt, calixarene, silicon compounds, styrene-acrylic acid copolymer, styrene-methacrylic acid copolymer, styrene-acryl-sulfonic acid copolymer, nonmetallic carboxylic compounds, modified substances with nigrosine and fatty acid metal salt, tributylbenzylammonium-1-hydroxy-4-naphtosulfonate, onium salts such as quaternary ammonium salt like tetrabutylammonium tetrafluoroborate and phosphonium salt which is an analog thereof and lake pigments thereof, triphenylmethane dyes and lake pigments thereof (examples of an agent for lake pigment include phosphorus tungstate, phosphorus molybdate, phosphotungsto-molybdic acid, tannic acid, lauric acid, gallic acid, ferricyanide, ferrocyanide, etc.), metal salts of higher fatty acid, diorganotin oxides such as dibutyltin oxide, dioctyltin oxide and dicyclohexyltin oxide, and diorganotin borates such as dibutyltin borate, dioctyltin borate and dicyclohexyltin borate.

These charge control agent may be used alone or in combination of two or more species.

The polarity of the spacer particle containing the above-mentioned charge control agent can be set by appropriately selecting a proper charge control agent from the above charge control agents. That is, the spacer particle can be positively charged or negatively charged relative to the surroundings.

Examples of a method of appropriately selecting a monomer from monomers containing a charge-prone monomer in producing the above spacer particle include the method of using substances having a hydrophilic functional group in combination as a monomer, which has been described in the description of the production of the spacer particle. The spacer particle can be positively charged or negatively charged relative to the surroundings by appropriately selecting a proper monomer from these monomers having a hydrophilic functional group.

Further, the spacer particle is preferably subjected to surface treatment in order to improve the adhesion to the substrate. Examples of a method of modifying the surface of the spacer particle include a method of modifying by precipitating resin on the surface of the spacer particle as disclosed, for example, in Japanese Kokai Publication Hei-1-247154; a method of modifying by reacting a compound which can react with a functional group on the surface of the spacer particle as disclosed in Japanese Kokai Publication Hei-9-113915 and Japanese Kokai Publication Hei-7-300587; and a method of modifying by conducting graft polymerization at the surface of the spacer particle as described in Japanese Kokai Publication Hei-11-223821 and Japanese patent application 2002-102848, but such a method that the spacer particles are charged is appropriately selected when these method are conducted.

Examples of the above-mentioned method of modifying the surface of the spacer particle include a method of forming a surface layer chemically combined on the surface of a spacer particle is preferred because problems of peeling of the surface layer or elution of the surface layer into liquid crystal in a cell of a liquid crystal display device are reduced.

Among others, a method of modifying by conducting graft polymerization described in Japanese Kokai Publication Hei-11-223821 is preferred. In such a method of conducting graft polymerization, the surface of a particle having a reducing group on the surface is graft-polymerized by reacting the particle with an oxidizing agent and producing a radical on the surface of the particle. When being graft-polymerized, it is possible to enhance the density of a surface layer of the spacer particle and form a surface layer having a sufficient thickness. Accordingly, the graft-polymerized spacer particle has excellent dispersibility in a spacer particle dispersion described later. Furthermore, when the spacer particle dispersion is ejected onto a substrate, the spacer particle has a high fixing property to the substrate. In order to perform charge treatment in this method, it is preferred to use a monomer having a hydrophilic functional group as a monomer together in performing graft polymerization.

And, the surface modification of the spacer particle like this also has effects of enhancing the adhesion of the spacer particle to the substrate or preventing the alignment defect of liquid crystal in a liquid crystal display by appropriately selecting a monomer to be used. Therefore, the spacer particle may be subjected to surface modification regardless of the presence or absence of charge treatment.

The above-mentioned spacer particle is preferably surface modified by graft polymerization. Specifically, it is preferred that a vinyl type thermoplastic resin, which is obtained by radically polymerizing a vinyl type monomer having a hydrophilic functional group and/or an alkyl group having 3 to 22 carbon atoms, is combined with the surface of the above spacer particle by graft polymerization.

The above-mentioned hydrophilic functional group is not particularly limited, and examples of the functional group include a hydroxyl group, a carboxyl group, a sulfonyl group, a phosphonyl group, an amino group, an amide group, an ether group, a thiol group and a thioether group, but among others, the hydroxyl group, the carboxyl group and the ether group are suitably used because of a few interactions with a liquid crystal. These hydrophilic functional groups may be used alone or in combination of two or more species.

A vinyl type monomer having the above-mentioned hydrophilic functional group is not particularly limited and examples of the monomer include vinyl type monomers having a hydroxyl group such as 2-hydroxyethyl (meth)acrylate, 1,4-hydroxybutyl(meth)acrylate, (poly)caprolactone modified hydroxyethyl(meth)acrylate, allyl alcohol, and glycerin monoallyl ether; acrylic acids such as (meth)acrylic acid, α-ethylacrylic acid and crotonic acid, and α-alkyl derivatives or β-alkyl derivatives thereof; unsaturated dicarboxylic acids such as fumaric acid, maleic acid, citraconic acid and itaconic acid; vinyl monomers having a carboxyl group such as mono2-(meth)acryloyloxyethyl ester derivatives of the above unsaturated dicarboxylic acids; vinyl type monomers having a sulfonyl group such as t-butyl acryl amide sulfonic acid, styrenesulfonic acid and 2-acrylamido-2-methyl propane sulfonic acid; vinyl type monomers having a phosphonyl group such as vinyl phosphate and 2-(meth)acryloyl oxyethylphosphate; vinyl type monomers having an amino group such as dimethylaminoethyl methacrylate and diethylaminoethyl methacrylate; vinyl type monomers having an ether group such as terminal alkyl ether of (poly)ethylene glycol(meth)acrylate, terminal alkyl ether of (poly)propylene glycol(meth)acrylate and tetrahydrofurfuryl(meth)acrylate; vinyl type monomers having both a hydroxyl group and an ether group such as (poly)ethylene glycol(meth)acrylate and (poly)propylene glycol(meth)acrylate; and vinyl type monomers having an amide group such as (meth)acrylamide, methylol(meth)acrylamide and vinylpyrrolidone. These vinyl type monomers having a hydrophilic functional group may be used alone or in combination of two or more species.

The above-mentioned alkyl group having 3 to 22 carbon atoms is not particularly limited, and examples of the alkyl group include n-propyl group, i-propyl group, n-butyl group, i-butyl group, t-butyl group, n-pentyl group, n-hexyl group, cyclohexyl group, 2-ethylhexyl group, n-heptyl group, n-octyl group, n-nonyl group, decyl group, undecyl group, dodecyl group, tridecyl group, tetradecyl group, pentadecyl group, nonadecyl group, eicodecyl group, henicosyl group, docosyl group, and isobornyl group. These alkyl groups having 3 to 22 carbon atoms may be used alone or in combination of two or more species.

A vinyl type monomer having the above alkyl group having 3 to 22 carbon atoms is not particularly limited, and examples of the vinyl type monomer include ester compounds comprising a (meth)acrylic acid and the above alkyl group having 3 to 22 carbon atoms; ester compounds comprising vinyl alcohol and the above alkyl group having 3 to 22 carbon atoms; and vinyl ether compounds comprising a vinyl group and the above alkyl group having 3 to 22 carbon atoms. These vinyl type monomers having an alkyl group having 3 to 22 carbon atoms may be used alone or in combination of two or more species. Further, the above vinyl type monomers having a hydrophilic functional group and the above vinyl type monomers having an alkyl group having 3 to 22 carbon atoms may be used alone, or both monomer may be used in combination.

Furthermore, the above vinyl type monomer composing the above vinyl thermoplastic resin is preferably obtained by containing 30 to 80% by weight of the above vinyl monomers having a hydrophilic functional group and 20 to 60% by weight of the above vinyl monomers having an alkyl group having 3 to 22 carbon atoms.

When the content of the vinyl type monomers having a hydrophilic functional group in the vinyl type monomer is less than 30% by weight, it becomes difficult to disperse adequately in the form of a single particle in the spacer particle dispersion medium containing the spacer particle to be obtained, and the aggregation of the particles is apt to occur, and it may become difficult to eject stably or it may become difficult to form a cell gap precisely, and on the contrary, when the content of the vinyl type monomers having a hydrophilic functional group in the vinyl type monomer is more than 80% by weight, abnormal alignment is apt to occur in the surface of the spacer particle going over into the display pixel in forming a cell of a liquid crystal display device, leading to the deterioration of display quality.

Moreover, when the content of the vinyl type monomers having an alkyl group having 3 to 22 carbon atoms in the vinyl type monomer is less than 20% by weight, abnormal alignment is apt to occur in the surface of the spacer particle going over into the display pixel in forming a cell of a liquid crystal display device, leading to the deterioration of display quality, and when the content of the vinyl type monomers having an alkyl group having 3 to 22 carbon atoms in the vinyl type monomer is more than 60% by weight, the dispersion stability of the spacer particle to be obtained in a medium may be deteriorated.

Further, when a plurality of vinyl thermoplastic resin layers having different composition is laminated for the purpose of increasing a thickness of a surface cover layer of the spacer particle by combining a vinyl thermoplastic resin, which is obtained by radically polymerizing a vinyl monomer having a hydrophilic functional group and/or an alkyl group having 3 to 22 carbon atoms, with the surface of the above spacer particle by graft polymerization, the use of the above preferred vinyl type monomer obtained by containing 30 to 80% by weight of the above vinyl type monomers having a hydrophilic functional group and 20 to 60% by weight of the above vinyl type monomers having an alkyl group having 3 to 22 carbon atoms may be considered for only the vinyl thermoplastic resin, which becomes the outermost layer of the surface cover layer. The reason for this is that functions such as dispersibility in the medium used for the spacer particle dispersion or the ink-jet ink and inhibition of abnormal alignment of liquid crystal is exerted based on the conditions in the vicinity of the surface of the spacer particle.

By performing such a surface treatment, movement of the spacer does not occur in an impact test after preparing a panel.

### (Spacer Particle Dispersion)

In the spacer particle dispersion of the first present invention, the above-mentioned spacer particles are dispersed in a medium which can disperses the spacer particles.

The surface tension of the spacer particle dispersion of the first present invention is not particularly limited as long as it is 33 mN/m or more and is not more than the surface tension of the liquid-contacting portion of the ink chamber in the head of the ink-jet device plus 2 mN/m. When the surface tension of the droplet of the dispersion ejected onto the substrate is high, it is suitable for moving the spacer particles in a drying process.

As a medium of the spacer particle dispersion of the first present invention, for example, various solvents, which are liquid at temperature at which the spacer particle dispersion is ejected, are used. Among others, a water-soluble or hydrophilic solvent is preferred. Incidentally, since nozzle heads of some ink-jet devices are fabricated for aqueous medium, a highly hydrophobic medium is not preferred when these heads are used because this medium may affect a member composing a head or may dissolve a part of adhesives bonding the member of the head, which bond the member.

Examples of the above-mentioned water-soluble or hydrophilic solvent include, in addition to water, monoalcohols such as ethanol, n-propanol, 2-propanol, 1-butanol, 2-butanol, 1-hexanol, 1-methoxy-2-propanol, furfuryl alcohol, tetrahydrofurfuryl alcohol; polymers of ethylene glycol such as ethylene glycol, diethylene glycol, triethylene glycol, tetraethylene glycol; polymers of propylene glycol such as propylene glycol, dipropylene glycol, tripropylene glycol, tetrapropylene glycol; lower monoalkyl ethers such as monomethyl ether, monoethyl ether, monoisopropyl ether, monopropyl ether and monobutyl ether of glycols, respectively; lower dialkyl ethers such as dimethyl ether, diethyl ether, diisopropyl ether and dipropyl ether; alkyl esters such as monoacetate and diacetate; diols such as 1,3-propanediol, 1,2-butanediol, 1,3-butanediol, 1,4-butanediol, 3-methyl-1,5-pentanediol, 3-hexene-2,5-diol, 1,5-pentanediol, 2,4-pentanediol, 2-methyl-2,4-pentanediol, 2,5-hexanediol, 1,6-hexanediol, neopentyl glycohol; polyhydric alcohols such as ether derivatives of diols, acetate derivatives of diols, glycerin, 1,2,4-butanetriol, 1,2,6-hexanetriol, 1,2,5-pentanetriol, trimethylol propane, trimethylol ethane, pentaerythritol, or ether derivatives thereof, acetate derivatives thereof, dimethyl sulfoxide, thiodiglycol, N-methyl-2-pyrrolidone, N-vinyl-2-pyrrolidone, γ-butyrolactone, 1,3-dimethyl-2-imidazolidine, sulfolane, formamide, N,N-dimethylformamide, N,N-diethylformamide, N-methylformamide, acetamide, N-methylacetamide, α-terpineol, ethylene carbonate, propylene carbonate, bis(β-hydroxyethyl)sulfone, bis(β-hydroxyethyl)urea, N,N-diethylethanolamine, abietynol, diacetone alcohol and urea.

In the spacer particle dispersion of the first present invention, the surface tension of the spacer particle dispersion of the first present invention is adjusted to 33 mN/m or more by combining the spacer particle dispersion with the above-mentioned solvent. When the surface tension of the spacer particle dispersion of the first present invention is lower than 33 mN/m, it is not preferred since a diameter of a droplet of the spacer particle dispersion of the first present invention, which has been deposited to the surface of the substrate, becomes large.

When the surface tension of the spacer particle dispersion of the first present invention is more than the surface tension of the above liquid-contacting portion plus 2 mN/m, the affinity of the spacer particle dispersion for the side wall of the ink chamber in a head becomes low and for example, a problem that air bubbles remain within the ink chamber may arise or a nozzle from which the spacer particle dispersion of the first present invention is not ejected may be produced.

As a method of adjusting the surface tension of the spacer particle dispersion of the first present invention to 33 mN/m or more, it is preferred to contain a solvent having a boiling point of less than 100° C. and a solvent having a boiling point of 100° C. or more as a medium of the spacer particle dispersion of the first present invention. It is more preferred to contain an organic solvent having a boiling point of 70° C. or more and less than 100° C. as the solvent having a boiling point of less than 100° C.

In addition, the term boiling point referred to in the present invention means a boiling point at the condition of 1 atmosphere.

As the above-mentioned solvent having a boiling point of less than 100° C., for example, lower monoalcohols such as ethanol, n-propanol, 2-propanol and the like, and acetone are preferably used.

If a temperature of a medium becomes high in spraying the spacer particle dispersion of the first present invention and drying the spacer particle dispersion by drying of a solvent, this causes an alignment layer to be contaminated and impairs display image quality of a liquid crystal display device, and therefore a drying temperature cannot be so high. If the solvent having a boiling point of less than 100° C. like the above description is used, the drying temperature can be lowered and hence the alignment layer is not contaminated.

A preferred lower limit of the content of the above solvent having a boiling point of less than 100° C. contained in the spacer particle dispersion of the first present invention is 2% by weight and a preferred upper limit thereof is 15% by weight with respect to 100% by weight of the spacer particle dispersion of the first present invention except the spacer particles. When the content of the solvent having a boiling point of less than 100° C. is less than 2% by weight, it is not preferred since a drying speed of the dispersion at a relatively low drying temperature which is applied to the first present invention becomes low to reduce production efficiency. Moreover, when the content of the solvent having a boiling point of less than 100° C. is more than 15% by weight, the surface tension of the spacer particle dispersion becomes too low, and the droplet diameter becomes too large and therefore the spacer particles may gather hard after the droplet is deposited to the surface of the substrate, or the spacer particle dispersion of the first present invention near the nozzle of the ink-jet device is apt to be dried and therefore this may impair the ejecting property of the ink-jet device. Further, the spacer particle dispersion of the first present is apt to be dried during its production or in a tank, and consequently the possibility of producing aggregated spacers may become high.

Furthermore, the above-mentioned solvent having a boiling point of less than 100° C. preferably has a surface tension of 38 mN/m or less at 20° C., more preferably 25 mN/m or less. When the surface tension of a solvent is more than 38 mN/m, an ejecting property of an ink-jet device may become poor. Further, the surface tension at 20° C. of the solvent having a boiling point of 100° C. or more is preferably 38 mN/m or more.

By containing a solvent having a boiling point of less than 100° C. and a surface tension of 38 mN/m or less in the spacer particle dispersion of the first present invention, it becomes easy to introduce the spacer particle dispersion of the first present invention into an ink-jet device described later and it becomes possible to improve an ejecting property in ejecting the spacer particle dispersion.

In addition, as described above, it is preferred that the spacer particle dispersion of the first present invention contains the above solvent having a boiling point of less than 100° C. and a solvent having a boiling point of 100° C. or more. The solvent having a boiling point of 100° C. or more is preferably a mixture of water and a solvent having a boiling point of 150° C. or more, and more preferably a mixture of water and a solvent having a boiling point of 150° C. or more and 250° C. or less. More preferred upper limit is 200° C.

In the spacer particle dispersion of the first present invention, by mixing a solvent having a boiling point of 150° C. or more and 250° C. or less and a surface tension of 38 mN/m or more, it becomes easy to adjust the receding contact angle to 5 degree or more. That is, after a droplet of the spacer particle dispersion of the first present invention is deposited to the surface of the substrate, a solvent having a boiling point of less than 100° C. and a low surface tension is evaporated in fast, and therefore the surface tension of the remaining dispersion becomes large, and therefore the spacer particle preferably becomes apt to move toward the center of a deposition area.

Conversely, if the surface tension of the solvent having a boiling point of 150° C. or more and 250° C. or less is less than 38 mN/m, after a droplet of the spacer particle dispersion of the first present invention is deposited to the surface of the substrate, a solvent having a boiling point of less than 100° C. and a low surface tension is evaporated in fast, and therefore the surface tension of the remaining dispersion becomes lower than an initial surface tension. Therefore, a diameter of the droplet having been deposited does not become small and the diameter of the droplet having been deposited becomes easy to spread compared with the initial, and therefore the spacer particle becomes hard to move toward the center of a deposition area.

Examples of the above solvent having a boiling point of 150° C. or more and 250° C. or less include, specifically, lower alcohol ethers such as ethylene glycol, diethylene glycol, propylene glycol, 1,2-butanediol. Such a solvent prevents the spacer particle dispersion of the first present invention from being dried excessively near the nozzle of the ink-jet device to reduce ejection accuracy. Further, since the spacer particle dispersion of the first present is not dried during its production or in a tank, the occurrence of aggregated spacers is inhibited.

The ratio of the solvent having a boiling point of 150° C. or more and 250° C. or less in the medium of the spacer particle dispersion of the first present invention is preferably within a range of 0.1 to 95% by weight, more preferably within a range of 0.2 to 90% by weight. When this ratio is less than 0.1% by weight, it is not preferred since the above reduction in ejection accuracy or production of aggregated particles due to drying of the dispersion tends to occur. When the ratio is more than 95% by weight or the boiling point is higher than 250° C., it takes significant time to dry the spacer particle dispersion, and therefore not only the efficiency is reduced, but also the display image quality of a liquid crystal display device tends to be deteriorated due to the contamination of an alignment layer.

Moreover, the spacer particle dispersion of the first present invention preferably has a receding contact angle (θr) of 5 degree or more to the substrate on which the spacer particle dispersion is ejected. When the above-mentioned receding contact angle is 5 degree or more, it becomes possible that one or more spacer particles of the first present invention contained in a droplet of the spacer particle dispersion of the first present invention, which has been deposited to the surface of the substrate, draw in the center of the droplet as the droplet is dried and contracts toward its center. Further, when charged ink is ejected there, the spacer particle becomes easy to move to a deposition area of charged ink based on a force electrostatically acting and the arrangement accuracy of the spacer particle is improved further.

When the above-mentioned receding contact angle (θr) is less than 5 degree, spacer particles become hard to gather in the center of a deposition area as the droplet is dried around the center of a deposition area (deposition center) of a droplet on the substrate and its droplet diameter contracts.

By the way, herein, a receding contact angle refers to a contact angle exhibited at the time when a droplet of the spacer particle dispersion of the first present invention, located on the surface of the substrate, becomes smaller than a diameter of a droplet having been deposited at the time of being located first on the substrate (the time when a droplet begins to contract) in a process from being located on the substrate to drying, or a contact angle exhibited at the time when 80 to 95% by weight of volatile components in the droplet has been vaporized.

Examples of a method of adapting the above receding contact angle so as to be 5 degree or more include a method of adjusting the composition of the dispersion medium of the spacer particle dispersion of the first present invention described above or a method of controlling the surface of the substrate.

In order to adjust the composition of the dispersion medium of the spacer particle dispersion of the first present invention, a medium having a receding contact angle of 5 degree or more may be used alone, or a mixture of two or more species of the mediums may be used. When the mixture of two or more species of the mediums, it is preferred since adjustments of the dispersibility of the spacer particle of the first present invention, and adjustments of the workability and the drying speed of the spacer particle dispersion of the first present invention are easy.

When two or more species of solvents are mixed to be used as the spacer particle dispersion of the first present invention, the solvents are preferably mixed in such a way that a receding contact angle (θr) of a solvent having the highest boiling point in the solvents to be mixed is 5 degree or more. When the receding contact angle (θr) of a solvent having the highest boiling point is less than 5 degree, a droplet diameter becomes large (a droplet wets the substrate surface and spreads over the substrate) in a late phase of drying and the spacer particles become hard to gather in the center of a deposition area on the substrate.

By the way, it was found in the course of completion of the present invention that a receding contact angle tends to become smaller than the so-called contact angle (this means an initial contact angle at the time when a droplet is placed on a substrate and this is commonly referred to as a contact angle in most cases). The reason for this is conceivable that the initial contact angle is a contact angle of the droplet to the substrate on the surface of the substrate which does not come into contact with a solvent composing the spacer particle dispersion and on the other hand the receding contact angle is a contact angle of the droplet to the substrate on the surface of the substrate after coming into contact with a solvent composing the spacer particle dispersion. That is, when the receding contact angle is significantly smaller than the initial contact angle, this shows that these solvents cause damage to an alignment layer and it was also found that use of these solvents is not preferable for the contamination of the alignment layer.

The spacer particle dispersion of the first present invention is preferably adjusted in such a way that the initial contact angle θ to the surface of the substrate is 10 to 110 degree. When the initial contact angle of the spacer particle dispersion of the first present invention over the surface of the substrate is less than 10 degree, a droplet of the spacer particle dispersion of the first present invention ejected onto the substrate becomes wetting the substrate and spreading over the substrate and therefore there may be cases where arrangement pitch of the spacer particle cannot be decreased, and when it is more than 110 degree, a droplet tends to move about on the substrate by little vibrations and consequently problems that arrangement accuracy is deteriorated or the adhesion of the spacer particle to the substrate is deteriorated arise.

Viscosity of the spacer particle dispersion of the first present invention at the time of ejecting the dispersion is preferably within a range of 0.5 to 15 mPa·s and more preferably within a range of 5 to 10 mPa·s. When the viscosity at the time of ejecting is higher than 15 mPa·s, there may be cases where the spacer particle dispersion cannot be ejected with an ink-jet device, and when the viscosity is lower than 0.5 mPa·s, it may become impossible to stably eject the spacer particle dispersion, for example, it becomes difficult to control an ejection amount even if the spacer particle dispersion can be ejected. In addition, liquid temperature in ejecting the spacer particle dispersion of the first present invention may be adjusted between −5 to 50° C., for example, by controlling a temperature of a head of an ink-jet device through cooling by a Peltier element or coolant or heating by a heater and the like in ejecting the spacer particle dispersion of the first present invention.

The concentration of solid matter of the spacer particle in the spacer particle dispersion of the first present invention is preferably within a range of 0.01 to 10% by weight and more preferably within a range of 0.1 to 39% by weight. When this concentration is less than 0.01% by weight, it is not preferred since a probability of not containing the spacer particle in a droplet ejected increases. When it is more than 10% by weight, it is not preferred since a nozzle of an ink-jet device may clog, and number of spacers contained in a droplet of the dispersion having been deposited becomes too many and therefore the spacer particles become hard to move in the drying process.

Further, spacer particles are preferably dispersed in the form of a single particle in the spacer particle dispersion of the first present invention. When aggregated matters are present in the dispersion, it is not preferred since not only they cause the reduction in ejection accuracy, but also they may cause clogging of a nozzle of an ink-jet device in an extreme case.

Moreover, to the extent of not inhibiting effects of the present invention, adhesive component for imparting adhesion to the spacer particle dispersion of the first present invention may be added, or a variety of surfactants or viscosity adjustors may be added for the purpose of improving the dispersion of the spacers, and the ejection accuracy through controlling physical properties such as the surface tension and the viscosity, and the mobility of the spacer.

In the spacer particle dispersion of the second present invention, the above-mentioned spacer particles are dispersed in a medium which can disperses the spacer particles.

The spacer particle dispersion of the second present invention is adjusted so as to have a receding contact angle (θr) of 5 degree or more over the substrate and a water content of 10% by weight or less.

Examples of the medium of the spacer particle dispersion of the second present invention include substances similar to the mediums of the spacer particle dispersion of the first present invention described above.

In the spacer particle dispersion of the second present invention, it is preferred that the spacer particle dispersion contains a solvent having a boiling point of 100° C. or more. Further, it is preferred to use only a solvent having a surface tension of 38 mN/m or more as the solvent having a boiling point of 100° C. or more. By using only the solvent having surface tension of 38 mN/m or more as the solvent having a boiling point of 100° C. or more, a receding contact angle (θr) described later can be enhanced. Further, when ejecting the spacer particle dispersion, a diameter of the droplet having been deposited does not become large and the diameter of the droplet having been deposited becomes hard to spread compared with the initial, and therefore the spacer particle becomes easy to move toward the center of a deposition area. Accordingly, it is possible to arrange a spacer particle selectively with high accuracy on the substrate.

In the spacer particle dispersion of the second present invention, the surface tension of the spacer particle dispersion of the second present invention is preferably adjusted to 33 mN/m or more by combining the spacer particle dispersion with the above-mentioned solvent. When the surface tension of the spacer particle dispersion of the second present invention is lower than 33 mN/m, a diameter of a droplet of the spacer particle dispersion of the second present invention, which has been deposited to the surface of the substrate, may become too large.

As a method of adjusting the surface tension of the spacer particle dispersion of the second present invention to 33 mN/m or more, it is preferred to contain a solvent having a boiling point of less than 100° C. and a solvent heaving a boiling point of 100° C. or more. It is more preferred to contain an organic solvent having a boiling point of 70° C. or more and less than 100° C.

As the above-mentioned solvent having a boiling point of less than 100° C., for example, lower monoalcohols such as ethanol, n-propanol, 2-propanol and the like, and acetone are preferably used. If a temperature of a medium becomes high in spraying the spacer particle dispersion and drying the spacer particle dispersion by drying of a solvent, this causes an alignment layer to be contaminated and impairs display image quality of a liquid crystal display device, and therefore a drying temperature cannot be so high. If the solvent having a boiling point of less than 100° C. like the above description is used, the drying temperature can be lowered and hence the alignment layer is not contaminated.

A preferred lower limit of the content of the above solvent having a boiling point of less than 100° C. is 1.5% by weight and a preferred upper limit thereof is 80% by weight with respect to 100% by weight of the spacer particle dispersion of the second present invention except the spacer particles. When the content of the solvent having a boiling point of less than 100° C. is less than 1.5% by weight, it is not preferred since a drying speed of the dispersion at a relatively low drying temperature which is applied to the spacer particle dispersion of the second present invention becomes low to reduce production efficiency. Moreover, when the content of the solvent having a boiling point of less than 100° C. is more than 80% by weight, the spacer particle dispersion of the second present invention near the nozzle of the ink-jet device is apt to be dried and therefore this may impair the ejecting property of the ink-jet device. Further, the spacer particle dispersion of the second present is apt to be dried during its production or in a tank, and consequently the possibility of producing aggregated particles may become high.

In addition, the above-mentioned solvent having a boiling point of less than 100° C. preferably has a surface tension of less than 38 mN/m at 20° C., more preferably 25 mN/m or less. When the surface tension of a solvent is 38 mN/m or more, the surface tension of the spacer particle dispersion becomes too high, and therefore an ejecting property of an ink-jet device may become poor depending on the surface tension of the liquid-contacting portion of the ink chamber in the ink jet head. Further, the surface tension at 20° C. of the solvent having a boiling point of 100° C. or more is preferably 38 mN/m or more.

By containing a solvent having a boiling point of less than 100° C. and a surface tension of less than 38 mN/m in the spacer particle dispersion of the second present invention, it becomes easy to introduce the spacer particle dispersion of the second present invention into an ink-jet device described later and it becomes possible to improve an ejecting property in ejecting the spacer particle dispersion.

In addition, as described above, when the spacer particle dispersion of the second present invention contains water as the above solvent having a boiling point of less than 100° C., a water content is adjusted to 10% by weight or less. By limiting a water content contained in the spacer particle dispersion of the second present invention to 10% by weight or less, spacer particles dispersed in the spacer particle dispersion of the second present invention becomes hard to be settled. On the contrary, when a water content contained in the spacer particle dispersion of the second present invention is more than 10% by weight, since the viscosity of the spacer particle dispersion of the second present invention decreases, the spacer particles becomes apt to settle and the dispersion of spacer particles in the spacer particle dispersion of the second present invention becomes uneven. Therefore, when the spacer particle dispersion is ejected on a substrate, density variations of the spacer particles distributed on the substrate tends to occur.

Moreover, it is preferred that a water content is small from the viewpoint of limiting the settling of the spacer particle, but when the water content is too small, the viscosity of the spacer particle dispersion of the second present invention becomes too high, and some kinds of heads cannot eject the spacer particle dispersion, and therefore the water content is more preferably adjusted to 5 to 10% by weight. That is, when a head, in which the ejection of low viscosity spacer particle dispersion can be performed more stably than the ejection of high viscosity spacer particle dispersion, have to be used, if a water content is 5% by weight or less, it is necessary to lower the viscosity by heating the head, and therefore, problems that the system becomes complicated by installation of a heater and the like, or the spacer particle dispersion cannot be ejected if not installing the heater and the like arise.

The spacer particle dispersion of the second present invention preferably contains the solvent having a boiling point of less than 100° C. and a surface tension of less than 38 mN/m as well as the solvent having a boiling point of 150° C. or more and 250° C. or less. By mixing a solvent having a boiling point of 150° C. or more and 250° C. or less and a surface tension of 38 mN/m or more, the receding contact angle becomes larger. That is, after a droplet of the spacer particle dispersion of the second present invention is deposited to the surface of the substrate, a solvent having a boiling point of less than 100° C. and a low surface tension is evaporated early, and therefore the surface tension of the remaining dispersion becomes large, and therefore the spacer particle preferably becomes apt to move toward the center of a deposition area.

Conversely, if the surface tension of the solvent having a boiling point of 150° C. or more and 250° C. or less is less than 38 mN/m, after a droplet of the spacer particle dispersion of the second present invention is deposited to the surface of the substrate, a solvent having a boiling point of less than 100° C. and a low surface tension is evaporated early, and therefore the surface tension of the remaining dispersion becomes lower than an initial surface tension. Therefore, a diameter of the droplet having been deposited does not become small and the diameter of the droplet having been deposited becomes easy to spread compared with the initial, and therefore the spacer particle becomes hard to move toward the center of a deposition area.

Examples of the above solvent having a boiling point of 150° C. or more and 250° C. or less include substances similar to the solvents of the spacer particle dispersion of the first present invention described above.

The ratio of the solvent having a boiling point of 150° C. or more and 250° C. or less in the medium of the spacer particle dispersion of the second present invention is preferably within a range of 50 to 98.5% by weight, more preferably within a range of 60 to 95% by weight. When this ratio is less than 50% by weight, it is not preferred since the above reduction in ejection accuracy or production of aggregated particles due to drying of the dispersion tends to occur and an effect of inhibiting the settling of the spacer particle by increasing viscosity or specific gravity of the spacer particle dispersion of the second present invention through addition of this solvent becomes small. When the ratio is more than 98.5% by weight or the boiling point is higher than 250° C., it takes significant time to dry the spacer particle dispersion, and therefore not only the efficiency is reduced, but also the display image quality of a liquid crystal display device tends to be deteriorated due to the contamination of an alignment layer.

Viscosity of the spacer particle dispersion of the second present invention at 20° C. is preferably more than 10 mPa·s and less than 20 mPa·s. When the viscosity is 10 mPa·s or less, the spacer particles dispersed in the spacer particle dispersion of the second present invention becomes apt to settle with time. When the viscosity is 20 mPa·s or more, there may be cases where it becomes difficult to control an ejection amount and the spacer particle dispersion of the second present invention has to be heated excessively in order to further improve an ejecting property when the spacer particle dispersion is ejected with an ink-jet device.

A specific gravity at 20° C. of the spacer particle dispersion of the second present invention is preferably 1.00 g/cm³ or more. When the specific gravity is less than 1.00 g/cm³, the spacer particles dispersed in the spacer particle dispersion of the second present invention becomes apt to settle with time.

In the spacer particle dispersion of the second present invention, a settling speed of the spacer particle dispersion of the second present invention is set at 150 minutes or more by appropriately setting species of the solvent and an amount of the solvent to be mixed. In addition, a settling speed refers to a time lapsed until the precipitation of the spacer particle dispersion was visually observed at the bottom of a test tube when the test tube was left standing after the spacer particle dispersion of the second present invention is introduced into the test tube with an inner diameter φ of 5 mm to the height of 10 cm.

When the settling speed of the spacer particle dispersion of the second present invention is 150 minutes or more, the spacer particle hardly settle during the duration between the introduction of the spacer particle dispersion of the second present invention into an ink-jet device and the ejection of the spacer particle dispersion. Therefore, it is possible to stably eject the spacer particle dispersion of the second present invention and arrange the spacer particle selectively on the substrate with high accuracy with an ink-jet device.

Further, the spacer particle dispersion of the second present invention has a receding contact angle (θr) of 5 degree or more to the substrate on which the spacer particle dispersion is ejected. When the above-mentioned receding contact angle is 5 degree or more, it becomes possible that one or more spacer particles contained in a droplet of the spacer particle dispersion of the second present invention, which has been deposited to the surface of the substrate, draw in the center of the droplet as the droplet is dried and contracts toward its center. When charged ink based on a force electrostatically acting has been deposited to the above-mentioned center in advance or there is a step within a diameter of a droplet having been deposited, the spacer particle becomes easy to move there and the arrangement accuracy of the spacer particle is improved further.

When the above-mentioned receding contact angle (θr) is less than 5 degree, since the droplet is dried around the center of a deposition area (deposition center) of a droplet on the substrate but its droplet diameter does not contract, spacer particles become hard to gather in the center of a deposition area.

Examples of a method of adapting the above receding contact angle so as to be 5 degree or more include a method of adjusting the composition of the dispersion medium of the spacer particle dispersion of the second present invention described above or a method of controlling the surface of the substrate.

In order to adjust the composition of the dispersion medium of the spacer particle dispersion of the second present invention, a medium having a receding contact angle of 5 degree or more may be used alone, or a mixture of two or more species of the mediums may be used. When the mixture of two or more species of the mediums is used, it is preferred since adjustments of the dispersibility of the spacer particle and the workability and the drying speed of the spacer particle dispersion of the second present invention are easy.

When two or more species of solvents are mixed to be used as the spacer particle dispersion of the second present invention, the solvents are mixed in such a way that a receding contact angle (θr) of a solvent having the highest boiling point in the solvents to be mixed is 5 degree or more. When the receding contact angle (θr) of a solvent having the highest boiling point is less than 5 degree, a droplet diameter becomes large (the droplet wets the substrate surface and spreads over the substrate) in a late phase of drying and the spacer particles become hard to gather in the center of a deposition area on the substrate.

By the way, it was found in the course of completion of the present invention that a receding contact angle tends to become smaller than the so-called contact angle (this means an initial contact angle at the time when a droplet is placed on a substrate and this is commonly referred to as a contact angle in most cases). The reason for this is conceivable that the initial contact angle is a contact angle of the droplet to the substrate on the surface of the substrate which does not come into contact with a solvent composing the spacer particle dispersion and on the other hand the receding contact angle is a contact angle of the droplet to the substrate on the surface of the substrate after coming into contact with a solvent composing the spacer particle dispersion. That is, when the receding contact angle is significantly smaller than the initial contact angle, this shows that these solvents cause damage to an alignment layer and it was also found that use of these solvents is not preferable for the contamination of the alignment layer.

In addition, the spacer particle dispersion of the second present invention is preferably adjusted in such a way that the initial contact angle θ to the surface of the substrate is 10 to 110 degree as with the spacer particle dispersion of the first present invention described above.

Viscosity of the spacer particle dispersion of the second present invention at the time of ejecting the dispersion, and the concentration of solid matter of the spacer particle in the spacer particle dispersion of the second present invention are preferably similar to those of the spacer particle dispersion of the first present invention described above.

Moreover, spacer particles are preferably dispersed in the form of a single particle as with the spacer particle dispersion of the first present invention described above in the spacer particle dispersion of the second present invention.

Furthermore, to the extent of not inhibiting effects of the present invention, adhesive component for imparting adhesion to the spacer particle dispersion of the second present invention may be added, or a variety of surfactants or viscosity adjustors may be added for the purpose of improving the dispersion of the spacers, and the ejection accuracy through controlling physical properties such as the surface tension and the viscosity, and the mobility of the spacer.

In the spacer particle dispersion of the third present invention, the above-mentioned spacer particles are dispersed in a medium which can disperses the spacer particles.

The spacer particle dispersion of the third present invention is adjusted in such a way that when the spacer particle obtained by drying the spacer particle dispersion is mixed with a liquid crystal, the rate of change of a volume resistivity of the liquid crystal is 1% or more and a change of a nematic-isotropic phase transition temperature of the above-mentioned liquid crystal is within ±1° C.

Examples of the medium of the spacer particle dispersion of the third present invention include substances similar to the mediums of the spacer particle dispersion of the first present invention described above.

In the spacer particle dispersion of the third present invention, it is preferred that the surface tension of the spacer particle dispersion is adjusted to 33 mN/m or more by combining the spacer particle dispersion with the above-mentioned medium. When the surface tension of the spacer particle dispersion is 33 mN/m or more, a diameter of a droplet of the spacer particle dispersion of the third present invention, having been deposited to the surface of the substrate, becomes small.

It is preferred that the spacer particle dispersion of the third present invention contain a solvent having a boiling point of 100° C. or more. It is more preferred that the spacer particle dispersion of the third present invention contains an organic solvent having a boiling point of 70° C. or more and less than 100° C.

As the above-mentioned solvent having a boiling point of less than 100° C., for example, lower monoalcohols such as ethanol, n-propanol, 2-propanol and the like, and acetone are preferably used.

If a medium of elevated temperature comes into contact with an alignment layer in spraying the spacer particle dispersion of the third present invention and drying the spacer particle dispersion by drying of a solvent, this causes an alignment layer to be contaminated and impairs display image quality of a liquid crystal display device, and therefore a drying temperature cannot be so high. However, if the solvent having a boiling point of less than 100° C. like the above description is used, the drying temperature can be lowered and hence the alignment layer is not contaminated.

A preferred lower limit of the content of the above solvent having a boiling point of less than 100° C. is 1.5% by weight and a preferred upper limit thereof is 80% by weight with respect to 100% by weight of the spacer particle dispersion of the third present invention except the spacer particles. When the content of the solvent having a boiling point of less than 100° C. is less than 1.5% by weight, it is not preferred since a drying speed of the dispersion at a relatively low drying temperature which is applied to the third present invention becomes low to reduce production efficiency. Moreover, when the content of the solvent having a boiling point of less than 100° C. is more than 80% by weight, the surface tension of the spacer particle dispersion of the third present invention becomes too low, and the droplet diameter becomes too large and therefore the spacer particles may gather hard after the droplet is deposited to the surface of the substrate, or the spacer particle dispersion of the third present invention near the nozzle of the ink-jet device is apt to be dried and therefore this may impair the ejecting property of the ink-jet device. Further, the spacer particle dispersion of the third present invention is apt to be dried during its production or in a tank, and consequently the possibility of producing aggregated particles may become high.

In addition, the above-mentioned solvent having a boiling point of less than 100° C. preferably has a surface tension of 38 mN/m or less at 20° C., more preferably 25 mN/m or less. When the surface tension of a solvent is 38 mN/m or more, an ejecting property of an ink-jet device may become poor. Further, the surface tension at 20° C. of the solvent having a boiling point of 100° C. or more is preferably 38 mN/m or more.

By containing a solvent having a boiling point of less than 100° C. and a surface tension of 38 mN/m or less in the spacer particle dispersion of the third present invention, it becomes easy to introduce the spacer particle dispersion of the first present invention into an ink-jet device described later and it becomes possible to improve an ejecting property in ejecting the spacer particle dispersion.

In addition, as described above, it is preferred that the spacer particle dispersion of the third present invention contains the above solvent having a boiling point of less than 100° C. and a solvent having a boiling point of 100° C. or more. The solvent having a boiling point of 100° C. or more is preferably a mixture of water and a solvent having a boiling point of 150° C. or more, and more preferably a mixture of water and a solvent having a boiling point of 150° C. or more and 200° C. or less.

In the spacer particle dispersion of the third present invention, by mixing a solvent having a boiling point of 150° C. or more and a surface tension of 38 mN/m or more, it becomes easy to adjust the receding contact angle to 5 degree or more. That is, after a droplet of the spacer particle dispersion of the third present invention is deposited to the surface of the substrate, a solvent having a boiling point of less than 100° C. and a low surface tension is evaporated early, and therefore the surface tension of the remaining dispersion becomes large, and therefore the spacer particle preferably becomes apt to move toward the center of a deposition area.

Conversely, if the surface tension of the solvent having a boiling point of 150° C. or more is less than 38 mN/m, after a droplet of the spacer particle dispersion of the third present invention is deposited to the surface of the substrate, a solvent having a boiling point of less than 100° C. and a low surface tension is evaporated early, and therefore the surface tension of the remaining dispersion becomes lower than an initial surface tension, and therefore, a diameter of the droplet having been deposited does not become small and the diameter of the droplet having been deposited becomes easy to spread compared with the initial, and therefore the spacer particle becomes hard to move toward the center of a deposition area.

Examples of the above solvent having a boiling point of 150° C. or more include substances similar to the solvents of the spacer particle dispersion of the first present invention described above.

The ratio of the solvent having a boiling point of 150° C. or more in the medium of the spacer particle dispersion of the third present invention is preferably within a range of 0.1 to 95% by weight, more preferably within a range of 0.2 to 90% by weight. When this ratio is less than 0.1% by weight, it is not preferred since the above reduction in ejection accuracy or production of aggregated particles due to drying of the dispersion tends to occur. When the ratio of the solvent is more than 95% by weight or the boiling point of the solvent is higher than 200° C., it takes significant time to dry the spacer particle dispersion, and therefore not only the efficiency is reduced, but also the display image quality of a liquid crystal display device tends to be deteriorated due to the contamination of an alignment layer.

As the spacer particle dispersion of the third present invention, a substance having a low content of a non-volatile component in the spacer particle dispersion except the spacer particles is suitably used. Specifically, substances having low contents of the non-volatile components such as dust in the air, impurities contained in a solvent used for dispersing the spacer particles, and crushed pieces of the spacer particle is suitably used. Further, the above-mentioned non-volatile component includes solid matter not having a shape retaining property and no spherical fine particles in the spacer particle dispersion of the third present invention.

The content of a non-volatile component existing in the spacer particle dispersion of the third present invention is preferably less than 0.001% by weight with respect to 100% by weight of the spacer particle dispersion of the third present invention. When the content of the non-volatile component is 0.001% by weight or more, the liquid crystal or the alignment layer is contaminated, and this display image quality of a liquid crystal display device such as contrast may become poor.

Examples of a method in which an content of the non-volatile component in the spacer particle dispersion of the third present invention is reduced to adjust the contents of the non-volatile component to the above-mentioned content include a method of using a solvent from which impurities are removed by a precision distillation, and a method in which first, the spacer particle dispersion is filtrated with a filter having a filter pore diameter larger than a particle size of the spacer particle to remove large dust and next the spacer particle dispersion is subjected to centrifugal operation to precipitate the spacer particles and then supernatant liquid was discarded and a solvent filtrated with a filter having a filter pore diameter of 1 μm is added to the separated spacer particle to disperse the spacer particles in the solvent. Alternatively, examples of this method also include a method in which the spacer particles are separated by filtration using a filter having a filter pore diameter smaller than a particle size of the spacer particle and the separated spacer particle is dispersed in a solvent filtrated with a filter having a filter pore diameter of 1 μl, and a method of using ion-adsorbing solid. These methods may be conducted repeatedly. Further, as apparatuses used for preservation in adjusting the above non-volatile component to the above-mentioned content, an apparatus which is low in the elution of the non-volatile component such as an ionic component and an organic matter is employed. As the apparatuses used for preservation, for example, a container of stainless steel, fluororesin, alkali-free glass, or bloomed glass is used.

As the above-mentioned ion-adsorbing solid, a laminar inorganic compound is preferably used. The above-mentioned laminar inorganic compound has highly design performance and imparts the functions and has unique properties and functions such as two dimensional physical properties and ion-exchange since it has a laminated structure unit having a certain property and a gap structure.

By employing the above-mentioned laminar inorganic compound, a metal atom existing between layers of the laminar inorganic compound catches ionic impurities. And, since the laminar inorganic compound has a laminar structure, the ionic impurities caught and adsorbed once is hardly reeluted.

The above-mentioned laminar inorganic compound is preferably a laminar silicate mineral.

Examples of the above-mentioned laminar silicate mineral include hydrotalcite group compounds, serpentine-kaoline group compounds, talc-pyrophyllite group compounds, smectite group compounds, vermiculite group compounds, mica group, interlayer defective mica compounds, brittle mica group compounds, chlorite group compounds, mixed layer mineral, diatomite, and aluminum silicate, and hydrotalcite group compounds and serpentine-kaoline group compounds are preferred. The above-mentioned laminar silicate mineral may be naturally occurring substances or synthetic substances. These laminar silicate minerals may be used alone or in combination of two or more species.

As the above-mentioned hydrotalcite group compounds, substances expressed by the following general formula (I) are preferred, and among others, Mg₆Al₂(OH)₁₆CO₃.4H₂O are suitable.

Mgₙ₁Alₙ₂(OH)ᵣ₁(CO₃)ᵣ₂.sH₂O (1)

In the above formula (I), n1, n2, r1, and r2 represent integers of 1 or more.

Examples of the above-mentioned serpentine-kaoline group compounds include lizardite, berthierine, amesite, cronstedite, nepouite, kellyite, fraiponite, brindleyite, kaolinite, dickite, nacrite, halloysite (planar), and odinite.

Examples of the above-mentioned talc-pyrophyllite group compounds include talc, willemseite, kerolite, pimelite, pyrophyllite, and ferripyrophyllite.

Examples of the above-mentioned smectite group compounds inclue saponite, hectorite, sauconite, stevensite, swinefordite, montmorillonite, beidellite, nontronite, and volkonskoite.

Examples of the above-mentioned vermiculite group compounds include trioctahedral vermiculite and diocathedral vermiculite.

Examples of the above-mentioned mica group compounds include biotie, phologopite, annite, eastonite, siderophyllite tetra-ferri-annite, lepidolite, polylithionite, muscovite, celadonite, ferroceladonite, ferro-aluminoceladonite, aluminoceladonite, tobelite, and paragonite.

Examples of the above-mentioned interlayer-deficient mica compounds include diocathedral (illite, glauconite, and brammallite) and trioctahedral (wonesite).

Examples of the above-mentioned brittle mica group compounds include clintonite, kinoshitalite, bityite, anandite, and margarite.

Examples of the above-mentioned chlorite group compounds include clinochlore, chamosite, pennantite, nimite, baileychlore, donbassite, cookeite, and sudoite.

Examples of the above-mentioned regulary interstratified mineralsp include corrensite, hydrobiotite, aliettite, kulkeite, rectorite, tosudite, dozylite, lunijianlaite, and Saliotite.

The above-mentioned ion-adsorbing solid is preferably particulate solid so that it can be easily separated after coming into contact with the spacer particle dispersion of the third present invention. Further, the shape of the above-mentioned ion-adsorbing solid is not particularly limited, and the particle diameter of the solid is preferably small for the purpose of increasing an opportunity to come into contact with ionic impurities but preferably 2 μm or more to avoid a problem of clogging in filtration.

Examples of a method, in which a content of the non-volatile component in the spacer particle dispersion of the third present invention is reduced to adjust the contents of the non-volatile component to the above-mentioned content using the above ion-adsorbing solid, include a method of using a cleaning solvent, from which ions are removed by passing the cleaning solvent through the above ion-adsorbing solid, as a cleaning solvent in cleaning the spacer particles, a method of passing a dispersion solution for a spacer particle before dispersing the spacer particles through the above ion-adsorbing solid to remove ions, and a method of passing a spacer particle dispersion, in which the spacer particles have been dispersed, through the above ion-adsorbing solid to remove ions.

In the spacer particle dispersion of the third present invention produced by using the above ion-adsorbing solid, the ionic impurities such as sodium ions, potassium ions, chlorine ions, acrylic acid, and methacrylic acid are removed and the elution of these impurities into a liquid crystal can be prevented.

The spacer particle dispersion of the third present invention preferably has a receding contact angle (θr) of 5 degree or more to the substrate on which the spacer particle dispersion is ejected as with the above-mentioned spacer particle dispersion of the first present invention.

Viscosity of the spacer particle dispersion of the third present invention at the time of ejecting the dispersion, and the concentration of solid matter of the spacer particle in the spacer particle dispersion of the third present invention are preferably similar to those of the spacer particle dispersion of the first present invention described above.

Preferably, the spacer particle dispersion of the third present invention does not contain solid non-volatile substances which do not cause changes of a volume resistivity and of a nematic-isotropic phase transition temperature from the viewpoint of a cell gap or optical characteristics. The content of such a non-volatile component is preferably less than 0.001% by weight with respect to 100% by weight of the spacer particle dispersion of the third present invention. When the content of the non-volatile component is 0.001% by weight or more, the liquid crystal or the alignment layer is contaminated, and the display image quality of a liquid crystal display device such as contrast may become poor.

Further, spacer particles are preferably dispersed in the form of a single particle as with the spacer particle dispersion of the first present invention described above in the spacer particle dispersion of the third present invention.

Furthermore, to the extent of not inhibiting effects of the present invention, adhesive component for imparting adhesion to the spacer particle dispersion of the third present invention may be added, or a variety of surfactants or viscosity adjustors may be added for the purpose of improving the dispersion of the spacers, and the ejection accuracy through controlling physical properties such as the surface tension and the viscosity, and the mobility of the spacer.

### (Ink-Jet Device)

Next, an ink-jet device used for ejecting the spacer particle dispersion onto the substrate will be described.

The ink-jet device used for the present invention is not particularly limited and ink-jet devices by common ejection methods such a piezo ink-jet method in which liquid is ejected by vibrations of a piazoelectric element; and a thermal ink-jet method in which liquid is ejected with the aid of the expansion of liquid by rapid heating are used. Among others, a piezo ink-jet method having less thermal effect on a substance to be ejected such as the spacer particle dispersion is suitably employed.

In the first present invention, in the method for producing a liquid crystal display device and the ink-jet device of the spacer particle dispersion used in this method for producing, a liquid-contacting portion of an ink chamber, receiving the spacer particle dispersion, in a head of the ink-jet device comprises a hydrophilic material having a surface tension of 31 mN/m or more. Further, the liquid-contacting portion may be comprises a hydrophilic material having a surface tension of 31 mN/m or more by hydrophilising with chemicals. On the other hand, in the spacer particle dispersion of the first present invention, the surface tension of the spacer particle dispersion is not particularly limited as long as the spacer particle dispersion comprises in such a way that the surface tension of the spacer particle dispersion is not more than the surface tension of the liquid-contacting portion plus 2 mN/m. Also, in the second and the third present inventions, a liquid-contacting portion of an ink chamber, receiving the spacer particle dispersion, of the ink-jet device preferably comprises a hydrophilic material having a surface tension of 31 mN/m or more.

As a material of the liquid-contacting portion, hydrophilic organic materials such as hydrophilic polyimide can be employed, or a material obtained by treating a head comprising a material of a liquid-contacting portion of a common ink chamber can be employed with a hydrophilising agent (oxidation treatment or coating of a hydrophilic organic thin film), but inorganic materials are used from the viewpoint of durability.

In a common head, a resin is used in this section for insulating from parts to apply a voltage, but it is not preferred because when such a material having a surface tension of less than 31 mN/m is used, air bubbles tends to remain in introducing the spacer particle dispersion into a head since this material has a low affinity for the spacer particle dispersion, and if the air bubbles remain, a nozzle containing these air bubbles cannot eject the spacer particle dispersion sometimes.

A liquid-contacting portion of an ink chamber in a head of the ink-jet device more preferably comprises a hydrophilic material having a surface tension of 40 mN/m or more. When the surface tension is 40 mN/m or more, the occurrence of non-ejecting nozzle is further inhibited and further an ejecting condition is stabilized. Examples of hydrophilic materials having a surface tension of 40 mN/m or more include ceramic, glass, and corrosion-inhibiting metals such as stainless steel.

In addition, a diameter of a nozzle hole of the above ink-jet device is preferably not less than 5 times larger than a diameter of the spacer particle. If the nozzle hole diameter is less than 5 times larger than a particle diameter, it is not preferred since ejection accuracy is reduced due to the too small nozzle hole diameter compared with the particle diameter, and extremely, the ejection of the spacer particles may become impossible due to nozzle clogging. More preferably, a nozzle hole diameter is 7 times or more.

The reason why the ejection accuracy is reduced is considered to be as follows. In the piezo ink-jet method, ink is drawn to an ink chamber close to the piezoelectric element or ejected from the ink chamber through a nozzle tip by vibrations of the piezoelectric element. As a method of ejecting droplets, there are a drawing and ejecting method in which a meniscus (interface between ink and vapor) at a nozzle tip is drawn in immediately before the ejection and then liquid is push out, and a pushing and ejecting method in which liquid is push out directly from a position where a meniscus is at rest on standby, but in common ink-jet devices, the former drawing and ejecting method goes mainstream and this method has a feature that small droplets can be ejected. In the ejection of the spacer particle dispersion of the present invention, since it is required that a diameter of the nozzle is large to some extent and smaller droplets are ejected, drawing and ejecting method is effective.

However, in the drawing and ejecting method, since the meniscus is drawn in immediately before the ejection, for example when the nozzle hole diameter is small such as less than 5 times larger than a particle diameter and the space particle 21 exists in the vicinity of the meniscus 22 drawn in as shown in FIG. 2(a), the meniscus 22 is not drawn in axisymmetrically. Therefore, it is thought that the droplets of the spacer particle dispersion 23 goes not straight ahead but at an angle in pushing out after drawing in, leading to the reduction in the ejection accuracies. For example when the nozzle hole diameter is large such as 7 times or more larger than a particle diameter, even though the space particle 21 exists in the vicinity of the meniscus 22 drawn in as shown in FIG. 2(b), the meniscus 22 is not affected by the spacer particle 21. Therefore, it is thought that the meniscus 22 is drawn in axisymmetrically, and the droplets of the spacer particle dispersion 23 goes straight ahead in pushing out after drawing in, leading to an increase in the ejection accuracies. However, if the nozzle hole diameter is increased unnecessary to prevent the droplet from going at an angle in ejecting the spacer particle dispersion, the droplet ejected becomes large and the diameter of a droplet having been deposited to the substrate also becomes large, and it is not preferred since the accuracies of arranging charged ink or the spacer particle 21 is deteriorated.

An amount of droplet ejected from a nozzle is preferably 10 to 80 μL in the spacer particle dispersion. As a method of controlling the amount of droplet, there are given a method of optimizing the nozzle hole diameter and a method of optimizing the electric signals controlling an ink-jet head. The latter is especially important when an ink-jet device of piezo ink-jet method is used.

In the ink-jet device, a plurality of nozzles described above is installed at an ink-jet head in a fixed arrangement form. For example, 64 or 128 nozzles are provided at a constant pitch in the direction perpendicular to the direction of ink-jet head movement. Further, there may be cases where these heads are installed in multiple rows such as two rows.

The nozzle pitch is restricted by a configuration of a piazoelectric element and the like or a nozzle diameter. Therefore, when the spacer particle dispersion is ejected onto the substrate with a pitch other than a pitch with which the above nozzles are located, it is difficult to prepare the head for each pitch. Thus, when a pitch with which the ejection is performed is smaller than the pitch of head, a head, generally located perpendicularly to the scanning direction of the head, is inclined on the plane parallel to the substrate or rotated while being kept in a state parallel to the substrate to eject the spacer particle dispersion. And, when this pitch is larger than the head pitch, the spacer particle dispersion is ejected by ejecting with only a part of nozzles instead of all nozzles or by inclining the ink-jet head.

Further, it is feasible to mount a plurality of such heads on an ink-jet device for the purpose of increasing productivity, but it requires caution since an increase in number of ink-jet heads causes the control to increase in complexity.

An example of a head of an ink-jet device used in the present invention is shown schematically in FIGS. 8(a) and 8(b). FIG. 8(a) is a partially broken perspective view showing schematically a structure of an example of an ink-jet head and FIG. 8(b) is a partially broken perspective view showing a cross section at a nozzle hole section. As shown in FIGS. 8(a), 8(b), a head 100 is provided with an ink chamber 101 in which ink is filled in advance through suction and the like and an ink chamber 102 into which ink is fed from the ink chamber 101. In the head 100, a nozzle hole 104 extending from the ink chamber 102 to the ejecting face 103 is provided. The ejecting face 103 has been subjected a water-repellent treatment for preventing the contamination due to ink. The head 100 is provided with a temperature control means 105 for adjusting the viscosity of ink. The head 100 includes a piazoelectric element 106 acting so as to feed ink from the ink chamber 101 to the ink chamber 102 and acting so as to eject ink from the nozzle hole 104.

Since the head 100 is provided with the above temperature control means 105, it is possible that when the viscosity of ink is too high, it can be reduced by heating ink by a heater, and when the viscosity of ink is too low, it can be increased by cooling by a Peltier element.

### (Substrate for Liquid Crystal Display Device)

As a first substrate and a second substrate for a liquid crystal display device used for the present invention, a material such as glass and a resin, which are generally used as a panel substrate of a liquid crystal display device, can be used. Further, a substrate in which a color filter is provided in its pixel area can be used for one substrate. In this case, the pixel area is defining a black matrix made of metal such as chromium or resin including dispersed carbon black, which substantively hardly passes light. This black matrix constitutes a non-pixel area.

### (Step of by Ejecting a Spacer Particle Dispersion with Spacer Particles Dispersed Using an Ink-Jet Device and Allowing a Droplet to be Deposited to the Surface of a First Substrate)

In the present invention, the spacer particle is arranged at a location corresponding to a non-pixel area by ejecting a spacer particle dispersion onto the surface of a first substrate or a second substrate with an ink-jet device.

In this time, the surface of the substrate, especially the location which a droplet of the spacer particle dispersion of the second present invention has been ejected onto and adhered to, is adjusted in such a way that a receding contact angle (θr) of the spacer particle dispersion is 5 degree or more, or when the spacer particle dispersion is a mixture comprising one or more species of solvents, the solvents are adjusted in such a way that a receding contact angle (θr) of a solvent having the highest boiling point in the solvents is 5 degree or more. It is preferred that similar adjustments are performed also with droplets of the spacer particle dispersions of the first and the third present inventions. In the case of charged ink, it is not necessary to adjust in such a way that a receding contact angle (θr) of the spacer particle dispersion is 5 degree or more as described above. However, there is no problem even if the receding contact angle has been adjusted to 5 degree or more.

Examples of a method of adjusting the above-mentioned receding contact angle to 5 degree or more include the above-mentioned method of selecting a solvent of the spacer particle dispersion and a method of bringing the surface of a substrate into low energy.

As the above method of bringing the surface of a substrate into low energy, a method of coating a resin having a surface with low energy such as a fluorine film and a silicone film may also be used, but a method of providing a resin thin film (usually, 0.1 μm or less) referred to as an alignment layer on the surface of the substrate is generally employed since it is necessary to regulate the alignment of a liquid crystal molecule. A polyimide resin film is generally used for this alignment layer. The polyimide resin film is obtained by thermal polymerization after coating solvent soluble polyamic acid or by coating and drying a soluble polyimide resin. As these polyimide resins, a resin having a side chain of a long chain and a main chain of a long chain is more preferred for attaining the surface with low energy. The above-mentioned alignment layer may be subjected to a rubbing treatment of the surface after being coated in order to control the alignment of liquid crystal. In addition, as the medium of the above spacer particle dispersion, a medium not having a property of contaminating the alignment layer by permeating or dissolving in the alignment layer have to be selected.

Further, in the present invention, the location of the first substrate, which the spacer particle dispersion has been ejected onto and adhered to, is preferably a surface with low energy. Herein, a location corresponding to the non-pixel area refers to either a non-pixel area (if a color filter substrate, the black matrix described above), or an area (if a TFT array substrate, a wiring portion) on the other substrate (if a TFT liquid crystal panel, a TFT array substrate), which corresponds to a non-pixel area in superimposing the other substrate on one substrate having the non-pixel area.

The surface energy of a location having the surface with low energy is preferably 45 mN/m or less, and more preferably 40 mN/m or less. When the surface energy is more than 45 mN/m, the droplet of the spacer particle dispersion becomes apt to wet and spread over the substrate as long as the spacer particle dispersion having the surface tension of a degree that the spacer particle dispersion can be ejected with an ink-jet device is used, and the spacer particle will go over the non-pixel area.

The surface with low energy obtained by applying the alignment layer and the like may be limited to a deposition area of the spacer particle or may cover the whole surface of the substrate. In consideration of the step of patterning and the like, the surface with low energy generally covers the whole surface area.

Further, in the present invention, there are locations having the surface with low energy in the area corresponding to the non-pixel area on the first substrate onto which the spacer particle dispersion is ejected, and the droplet of the spacer particle dispersion is ejected in such a way that the droplet after deposited to the substrate exists at the location having the surface with low energy, but the location having the surface with low energy may include a location having a step which is different in level from surroundings. Furthermore, it is more preferred that the charged ink is ejected and dried on only the location having a step.

Incidentally, the step referred to herein refers to concavities and convexities (difference in level from surroundings) unintentionally produced by wirings provided on the substrate, or concavities and convexities intentionally provided for gathering the spacer particles like the present invention, and structures of the surfaces of the concavities and convexities are indifferent. Accordingly, the step referred to herein means a difference in level between the convexity or concavity in the concavities and convexities of the surface and a flat portion (base level).

Specifically, for example, in the array substrate in a TFT liquid crystal panel, examples of the steps include the steps (about 0.2 μm) based on a gate electrode or a source electrode as shown in FIGS. 3(a) to 3(c), and the step (about 1.0 μm) based on an array as shown in FIG. 3(g). Further, in the color filter substrate, there are the steps (about 1.0 μm) based on a recession between color filter of image color on a black matrix as shown in FIGS. 3(d) to 3(f) and 3(h).

In the present invention, assuming a particle diameter of the spacer particle as D (μm) and a step as B (μm), the step is preferably a step in which a relationship of 0.01 μm<|B|<0.95 D holds. When the step is less than 0.01 μm, it may become difficult to gather the spacer particles around the step, and when it is more than 0.95 D, it may become difficult to attain an effect of controlling a gap between the substrates by the spacer particle.

In addition, with respect to the function of the step, it is explained that when the step exists, since a drying center of the droplet is approximately fixed to the step portion in an ultimate stage of drying, it is possible to gather the spacer particles in a very limited position near the steps existing in the area corresponding to the non-pixel area after drying the droplet of the spacer particle dispersion having been deposited to the substrate.

In this case, the position where the spacer particles 31 ultimately remain after drying is often at a corner for the convex portion and in a concavity for the concave portion as shown in FIG. 4.

Further, with respect to the function of the step, it is also thought that when there are metals at the step portion of wirings or in the vicinity of the steps on opposed sides of a thin film of the alignment layer and the spacer particle is surface modified or a charge control agent is contained, the particle moves to this portion and is adsorbed on this portion by an electrostatic interaction, that is, an electrostatic “electrophoretic” effect. In this case, a functional group of a compound used for surface treatment of wirings is changed by using a metal species or, for example, an ionic functional group, the charge control agent is added while adjusting the species of the charge control agent, or a positive or negative voltage is applied to wirings such as a source wiring and a gate wiring or the whole surface of a substrate to an extent of not breaking a circuit. By doing so, it is possible to control to gather the spacer particles.

In the present invention, the spacer particle dispersion is ejected to a position including the above-mentioned location corresponding to the non-pixel area on the substrate with an ink-jet device.

In the present invention, the spacer particle dispersion is preferably ejected onto the substrate at a pitch of the value of the following equation (1) or more. Further, this pitch is the shortest distance between one droplet and a next droplet in the case where the next droplet is ejected before the droplet of the spacer particle dispersion having been deposited to the substrate is dried.

$$\begin{matrix}[ eq . 1 ] & \\ 35 * {( \frac{D}{( 2 - 3 cos θ + {cos}^{3} θ )} )}^{1 / 3} ( µ m ) & ( 1 )\end{matrix}$$

θ: contact angle of the spacer particle dispersion to the surface of a substrate

In the above equation (1), D represents a particle diameter (μm) of the spacer particle and θ represents an initial contact angle of the spacer particle dispersion to the surface of a substrate.

When the droplet is ejected at a shorter pitch than the value of the above equation (1), since a droplet diameter is yet large, a droplet diameter having being deposited to the substrate becomes large to cause the coalescence of droplets and the spacer particles do not gather toward one location in a drying process. Consequently, a problem that the arrangement accuracy of the spacer particle after drying becomes poor arises. And, when a nozzle hole diameter is reduced for decreasing an amount of droplet ejected, a spacer particle diameter becomes large relative to the nozzle hole diameter, and therefore the spacer particle cannot be ejected stably, for example straight in the same direction always, from the ink-jet head nozzle as describes above, and since the droplet travels at an angle, the positioning accuracy of a deposition area is deteriorated. Also, the nozzle may be clogged with the spacer particle. Further, FIG. 10 is a schematic view showing a state in which the spacer particle dispersion is ejected onto a substrate by the above method and the spacer particles are arranged through drying described later.

However, it is possible to arrange the droplets repeatedly in only one direction depending on the surface conditions. That is, preferably, on the surface of a substrate which is not so high in the contact angle or the receding contact angle, since the droplets coalesces in only one direction coalescing in the form of lod without coalescing radially, it becomes possible to arrange the spacer particles in the form of a line or a broken line in only one direction. FIG. 11 is a schematic view showing a state in which the spacer particle dispersion is ejected onto a substrate by such a method and the spacer particles are arranged through drying described later.

It is preferred that the number of spacer particles (density of the spacer particle distributed) which are ejected according to the above equation (1) and arranged on the substrate is generally 50 to 350 per an area of 1 mm². The spacer particle may be arranged in any position in an area corresponding to a non-pixel area such as a black matrix or a non-pixel area such as wirings in any pattern as long as it is a range to meet this density of particles. However, for a color filter comprising light-blocking areas (non-pixel area) in a grid pattern, it is more preferred to arrange the spacer particle aiming for a location corresponding to a grid point of the light-blocking area in a grid pattern on one substrate to prevent the spacer particle from going over into a display area (pixel area).

In addition, the number of spacer particles in one arrangement position varies from arrangement position to arrangement position, but it is generally about 0 to 12, and an average number of particles is about 2 to 6. This average number of particles is adjusted according to a particle size of the spacer particle and a concentration of the spacer particle dispersion.

Thus, examples of a method of adjusting the density of the spacer particle distributed include a method of modifying the concentration of the spacer particle in the spacer particle dispersion, a method of changing a pitch with which the spacer particle dispersion is ejected, and a method of changing an amount of a droplet ejected by one ejection.

Examples of the above method of changing an amount of a droplet having been deposited to one location include a method of adjusting a waveform of voltage of an ink-jet head and a method of ejecting the droplet onto one location multiple times.

When changing the density of the spacer particle distributed by the above method of modifying the concentration of the spacer particle in the spacer particle dispersion, species of the spacer particle contained in the spacer particle dispersion can also be changed. Accordingly, it becomes possible to change various properties such as a particle diameter and hardness of the spacer particle used, and a recovery rate from one specific area of the substrate to another specific area of the substrate.

As for the density of the spacer particle distributed, in a specific area of the substrate, it is preferred that the standard deviation of the density of the spacer particle distributed per an area of 1 mm² is 40% or lower of an average value of the density of the spacer particle distributed in the specific area. When the ink-jet device described above is used, the standard deviation can be easily limited within the above-mentioned range if the ink-jet device is in a ordinary state, namely, a normal ejecting condition that concentration variations or nozzle clogging due to settling of the spacer particles or generation of a non-ejecting nozzle due to remaining air bubbles in a nozzle do not occur. When the standard deviation is larger than 40% of an average value of the density of the spacer particle distributed, a cell gap between the substrates varies and this may adversely affect a state of display.

In addition, the number of spacer particles in one arrangement position varies from arrangement position to arrangement position, but it is generally about 0 to 12, and an average number of particles is about 2 to 6. This average number of particles is adjusted according to a particle size of the spacer particle and a concentration of the spacer particle dispersion.

Further, in order to eject the spacer particle dispersion and allow the droplet to be deposited to the surface of the substrate like this, scanning of the ink-jet head can be performed by one operation or can be divided into multiple scanning. Particularly when a pitch with which the spacer particles are going to be arranged is smaller than the value of the above equation (1), the spacer particle dispersion may be ejected with a pitch of an integral multiple of the pitch of arrangement and dried once, and then ejection may be shifted by this pitch to performed again. The direction of shift (scanning) may be alternately changed every times to eject the spacers (reciprocating ejection) or the eject of the spacer particles may be performed only during shift to one direction (one way ejection).

Further, as such an arrangement method, as described in Japanese patent application 2000-194956, a head is inclined so as to form an angle with the normal to a substrate plane, the direction of ejection of a droplet is changed (normally parallel with the normal to a substrate plane), and further a relative velocity between the head and the substrate is controlled. By doing like this, it is possible to reduce a diameter of the spacer particle the droplet having been deposited and it is possible to facilitate arranging the spacer particle in an area defining the pixel area or an area corresponding to the above-mentioned defining area.

### (Drying Method of Spacer Particle Dispersion)

Next, a step of drying the dispersion by drying a medium (solvent) in the dispersion after the spacer particle dispersion is deposited to the surface of the substrate will be described.

A method of drying the spacer particle dispersion is not particularly limited, and examples of the method include a method of heating a substrate, a method of blowing hot or cold air to a substrate, and a method of drying the spacer particle dispersion under a reduced pressure. However, in order to gather the spacer particles in the vicinity of the center of a droplet having been deposited in a drying process, it is preferred to set a boiling point of the medium, a drying temperature, a drying time, surface tension of the medium, a contact angle of the medium over an alignment layer, and a concentration of the spacer particle at proper conditions.

In order to put the spacer particles together in the droplet having been deposited to the substrate in a drying process, a drying time is maintained above a certain level to prevent liquid from disappearing during the spacer particles move over the substrate. Therefore, the conditions at which the medium is rapidly dried are not preferred. Further, if the medium comes into contact with the alignment layer at elevated temperature, it is not preferred because the medium may contaminate the alignment layer to impair the display quality as a liquid crystal display device. Accordingly, it is preferred to keep a temperature of the surface of the substrate 90° C. or less, more preferably 60° C. or less until drying of the spacer particle dispersion is completed. If the temperature of the substrate is more than 90° C. before drying is completed, it is not preferred because the medium damages the alignment layer to impair the display image quality of a liquid crystal display device.

When mediums which are significantly volatile at room temperature are used as a medium or these mediums are used under such a condition that the medium is intensely vaporized, it is not preferred because the spacer particle dispersion near the nozzle of the ink-jet device is apt to be dried to impair an ejecting property of ink-jet. Further, it is not preferred because there is a possibility to produce aggregated particles during production of the dispersion or due to drying in a tank.

Even though a substrate temperature is low, if a drying time is significantly long, it is not preferred since not only production efficiency of a liquid crystal display device is deteriorated, but also the contamination or the damage of an alignment layer occurs since an ink medium is in contact with an alignment layer for a long time.

In the present invention, a surface temperature of a substrate at the time when the spacer particle dispersion is deposited to the surface of the substrate is preferably lower than a boiling point of a solvent having the lowest boiling point contained in the dispersion by 20° C. or more. This surface temperature is more preferably around room temperature (15 to 35° C.). If the surface temperature becomes higher than a temperature which is lower than a boiling point of a solvent having the lowest boiling point by 20° C., it is not preferred because the solvent having the lowest boiling point is rapidly vaporized, and consequently not only the spacer particle cannot move in the droplet, but also the whole droplet moves over the substrate due to rapid boiling of the solvent in an extreme case and the arrangement accuracy of the spacer particle is significantly deteriorated.

Moreover, when the spacer particle dispersion is dried by drying the medium while elevating the temperature of the substrate gradually after the spacer particle dispersion is deposited to the substrate, it is preferred to keep the temperature of the surface of the substrate 90° C. or less, more preferably below 60° C. or less until drying of the spacer particle dispersion is completed. If the temperature of the substrate is more than 90° C. before drying is completed, it is not preferred because the medium damages the alignment layer to impair the display image quality of a liquid crystal display device.

Thus, as a drying method for preventing the damage to the alignment layer, it is preferred to dry at low temperature as far as possible for a short time. Specifically, it is preferred that a surface temperature of the substrate is kept below 60° C. and the droplet is dried within 5 seconds to 4 minutes (more preferably 5 seconds to 2 minutes) after the droplet comes into contact with the substrate. When drying is completed in a too short time, gathering of the spacer particles is deteriorated, and when drying is completed in a long time, the alignment layer is damaged.

A means for achieving this is to remove medium vapor near the droplet fast, that is, to blow air or to dry under a reduced pressure. However, since the too large volume of air causes the spacer particle to move about in the droplet, and consequently gathering of the spacer particles is impaired, the volume of air needs to be appropriately controlled.

However, some species of an alignment layer improves gathering of the spacer particles, the droplet may be dried at 90° C. or more for a short time. Specifically, it is preferred to dry at about 100 to 150° C. for about 5 to 20 seconds.

In addition, the term completion of drying in this description refers to a point of time that a droplet on the substrate disappears.

Thereafter, the substrate can be heated to a higher temperature (120 to 230° C.) in order to enhance the ability of the spacer particle to fix to the substrate or remove the remaining solvent.

### (Step of Superimposing First Substrate on Second Substrate Via Liquid Crystal and Spacer Particles with First Substrate Opposed to Second Substrate)

The substrate on which the spacer particles were arranged according to the present invention is attached to the substrate on which the spacer particles were not arranged by thermo-compression using a peripheral sealing material, and liquid crystal is filled into a space formed between the substrates to prepare a liquid crystal display device (vacuum filling method). Alternatively, a peripheral sealing material is applied to one of substrates and liquid crystal is added dropwise in an area surrounded with the sealing material on the substrate, and to this, the other substrate is bonded, and a sealing material is cured to prepare a liquid crystal display device (one drop fill method). In this case, the spacer particle may be arranged on either substrate.

In the method for producing a liquid crystal display device of the third present invention, the rate of change of a volume resistivity of the liquid crystal is 1% or more and a change of a nematic-isotropic phase transition temperature of the liquid crystal is within ±1° C. from before to after arranging the liquid crystal.

When the rate of change of a volume resistivity of the liquid crystal is 1% or more, display quality such as contrast and color tone of the liquid crystal display device is excellent. When the rate of change of a volume resistivity of the liquid crystal is less than 1%, the liquid crystal is contaminated by the contamination of foreign matter having conductivity which exists in the spacer particle dispersion of the third present invention, and the display quality of the liquid crystal display device is deteriorated, and image retention or display irregularity is generated. The rate of change of a volume resistivity of the liquid crystal is more preferably 10% or more. When the rate of change of a volume resistivity of the liquid crystal is 10% or more, the display quality of the liquid crystal display device is more excellent.

When the change of a nematic-isotropic phase transition temperature of the liquid crystal is within ±1° C., display quality such as contrast and color tone of the liquid crystal display device is excellent. When the change of a nematic-isotropic phase transition temperature of the liquid crystal is out of a range of ±1° C., impurities such as organic matter existing in the spacer particle dispersion of the third present invention becomes compatible with a liquid crystal to contaminate the liquid crystal, and thereby the display quality of the liquid crystal display device is deteriorated and image retention or display irregularity is generated.

The voltage retention of the liquid crystal display device thus constructed according to the method for producing a liquid crystal display device of the third present invention becomes 90% or more. When a liquid crystal display device is fabricated without according to the method for producing of the third present invention, the voltage retention is often less than 90%. When the voltage retention is less than 90%, a voltage drop may occur within a drive time of the pixel, and the display quality of the liquid crystal display device may be deteriorated and image retention or display irregularity may be generated.

The residual DC voltage of the liquid crystal display device thus constructed according to the method for producing a liquid crystal display device of the third present invention becomes 200 mV or less. When a liquid crystal display device is fabricated without according to the method for producing a liquid crystal display device of the third present invention, the residual DC voltage is often more than 200 mV. When the residual DC voltage is more than 200 mV, a voltage may remain in the pixel even after an application of a voltage is stopped, and the display quality is deteriorated by the generation of image retention or display irregularity. Incidentally, residual DC voltage is a measure of the contaminations of a liquid crystal and an alignment layer.

Hereinafter, the present invention will be described in more detail by way of examples, but the present invention is not limited to these examples.

### (Preparation of Spacer Particle)

In a separable flask, 15 parts by weight of divinylbenzene, 5 parts by weight of isooctyl acrylate and 1.3 parts by weight of benzoyl peroxide as a polymerization initiator were mixed uniformly. Next, to this mixture, 20 parts by weight of a 3% aqueous solution of polyvinyl alcohol (trade name “KURARAY POVAL GL-03”, produced by KURARAY CO., LTD.) and 0.5 parts by weight of sodium dodecyl sulfate were further charged and stirred well. Thereafter, 140 parts by weight of ion-exchanged water was added. This solution was reacted at 80° C. for 15 hours under nitrogen flow while being stirred to obtain particles. The resulting particles were washed with hot water and acetone and then classified to prepare spacer particles having an average particle diameter of 3.0 μm, 4.0 μm and 5.0 μm, and a CV value of 3.0%.

### (Surface Modification of Spacer Particle)

5 parts by weight of the obtained spacer particle having an average particle diameter of 3.0 μm, 4.0 μm and 5.0 μm and a CV value of 3.0% was charged into a mixture of 20 parts by weight of dimethyl sulfoxide (DMSO), 2 parts by weight of hydroxymethyl methacrylate and 18 parts by weight of N-ethylacrylamide, and the resulting mixture was dispersed uniformly with a sonicater. Thereafter, a nitrogen gas was introduced into a reaction system and the mixture was continuously stirred at 30° C. for 2 hours. Next, to this was added 10 parts by weight of a 0.1 mol/L solution of cerium di-ammonium nitrate prepared by a 1N aqueous solution of nitric acid and a reaction was continued for 5 hours. After the completion of the reaction, a reactant was separated into particles and a reaction solution through filtration using a 2 μm membrane filter. These particles were adequately washed with ethanol and acetone and then dried under reduced pressure with a vacuum drier to obtain spacer particles SA.

5 parts by weight of the spacer particle having an average particle diameter of 4.0 μm and a CV value of 3.0%, obtained through the above-mentioned preparation of spacer particles, was charged into a mixture of 20 parts by weight of dimethyl sulfoxide (DMSO), 2 parts by weight of hydroxymethyl methacrylate, 16 parts by weight of methacrylic acid and 2 parts by weight of lauryl acrylate, and the resulting mixture was dispersed uniformly with a sonicater. Thereafter, spacer particles SB were obtained by following the same procedure as in the above spacer particle SA.

5 parts by weight of the spacer particle having an average particle diameter of 4.0 μm and a CV value of 3.0%, obtained through the above-mentioned preparation of spacer particles, was charged into a mixture of 20 parts by weight of dimethyl sulfoxide (DMSO), 2 parts by weight of hydroxymethyl methacrylate and 18 parts by weight of polyethylene glycol methacrylate (molecular weight 800), and the resulting mixture was dispersed uniformly with a sonicater. Thereafter, spacer particles SC were obtained by following the same procedure as in the above spacer particle SA.

10 parts by weight of the spacer particle having an average particle diameter of 4.0 μm and a CV value of 3.0%, obtained through the above-mentioned preparation of spacer particles, was charged into a mixture of 20 parts by weight of methyl ethyl ketone and 3 parts by weight of a 30% toluene solution of methacryloyl isocyanate, and the resulting mixture was reacted at 100 to 150° C. for 1 to 2 hours to introduce a vinyl group in the surface of the spacer particle. Thereafter, a reactant was centrifuged to obtain spacer particles surface modified with a vinyl group. 10 parts by weight of the spacer particle into which a vinyl group was introduced was charged into a mixture of 1 part by weight of 2,2′-azobisisobutyronitrile, an initiator, and 100 parts by weight of methylcellosolve. Next, the resulting mixture was heated to 60° C. which is an initiator-cleavage temperature and reacted for 2 hours under nitrogen flow to produce a radical in the vinyl group in the particle surface. Thereafter, 5 parts by weight of hydroxymethyl methacrylate having a hydroxyl group, a homopolymer of which is a polymerized vinyl monomer capable of being dissolved in methylcellosolve, and 45 parts by weight of polyethylene glycol methacrylate (molecular weight 800) were added dropwise and the resulting mixture was reacted for 1 hour to form spacer particles having an adhesive layer comprising a graft-polymerized chain in the surface. After the completion of the reaction, a reactant was separated into spacer particles and a reaction solution through filtration using a 2 μm membrane filter. These spacer particles were adequately washed with ethanol and acetone and then dried under reduced pressure with a vacuum drier to obtain spacer particles SD surface modified by graft polymerization.

### EXAMPLES 1 TO 13, COMPARATIVE EXAMPLES 1 TO 3

### Preparation of Spacer Particle Dispersion

The spacer particles obtained by the above-mentioned method were taken by an amount required to obtain a given particle concentrations and these spacer particles were gradually added to solvents having the composition shown in Table 1 below and dispersed by being adequately stirred with a sonicater. Thereafter, the resulting spacer particle dispersions were filtrated with a stainless screen with mesh size of 10 μm to remove aggregated matters to obtain spacer particle dispersions S1 to S8. The surface tension of the obtained spacer particle dispersions was measured by a Wilhelmy method using a platinum plate. The results of measurements are shown in Table 1 below.

### (Preparation of Substrate)

A color filter substrate was used as a first substrate for a liquid crystal test panel and a liquid crystal display device substrate (TFT array model substrate) simulating the steps existing on a TFT array substrate was used as a second substrate.

### (Color Filter Substrate)

Either of two species of color filter substrates 21, 31 below was used in Examples and Comparative Examples.

FIG. 5(a) is a partial plan view, which magnifies and shows a part of a state of providing a glass substrate to be used for color filter substrates 41, 61 with black matrixes. FIG. 5(b) is a front sectional view showing the color filter substrate 41 and FIG. 5(c) is a partially broken front sectional view which magnifies and shows a part of the color filter substrate 61.

Color filter substrates 41 having a smooth surface used in Examples and Comparative Examples were prepared in the following manner. As shown in FIGS. 5(a), 5(b), black matrixes 43 (25 μm in width, pitch of 150 μm in length, pitch of 75 μm in width, 0.2 μm in thickness) comprising metal chromium was provided on a glass substrate 42 having a size of 300 mm×360 mm by a normal method. On and between the black matrixes 43, pixels (thickness 1.5 μm) of a color filter 44, comprising three colors of RGB, were formed in such a way that the surfaces of the pixels are flat. Thereon, an overcoat layer 45 and an ITO transparent electrode 46, which have a substantially uniform thickness, were installed. Furthermore, onto this, a solution (produced by NISSAN CHEMICAL INDUSTRIES, LTD, “SUNEVER SE1211”, surface tension (γ): 26 mN/m) containing polyimide was applied uniformly by spin coating method. After this application, the spacer particle dispersion was dried at 80° C. and then baked at 190° C. for 1 hour, and cured to form an alignment layer 47 having a substantially uniform thickness.

Next, a color filter substrate 61 provided with depressions (steps (depth) 1.3 μm) above the black matrixes 43 were prepared in the following manner.

As shown in FIG. 5(c), pixels (thickness 1.5 μm) of a color filter 62, comprising three colors of RGB, were formed at the locations on the glass substrate 42 in which black matrixes 43 was not provided. An overcoat layer 63 and an ITO transparent electrode 64, which have a substantially uniform thickness, were installed on the black matrixes 43 and the color filter 62. Furthermore, onto this, a solution (produced by NISSAN CHEMICAL INDUSTRIES, LTD, “SUNEVER SE1211”, surface tension (y): 26 mN/m) containing polyimide was applied uniformly by spin coating method. After this application, the spacer particle dispersion was dried at 80° C. and then baked at 190° C. for 1 hour, and cured to form an alignment layer 65 having a substantially uniform thickness.

### (TFT Array Model Substrate)

FIG. 6(a) is a partial plan view, which magnifies and shows a part of a state of providing a glass substrate to be used for a TFT array model substrate with steps. FIG. 6(b) is a front view showing a TFT array model substrate.

TFT array model substrates 51 provided with steps were prepared in the following manner.

As shown in FIG. 6(a), 6(b), in the TFT array model substrates 51, steps 53 (8 μm in width, 0.2 μm in thickness) comprising copper were provided at the positions, corresponding to black matrixes 43 of the above-mentioned color filter substrates 41, 61, on a glass substrate 52 having a size of 300 mm×360 mm by a publicly known method. Thereon, an ITO transparent electrode 54 having a substantially uniform thickness was installed, and furthermore, an alignment layer 55 having a substantially uniform thickness was formed by the method described above.

### (Arrangement of Spacer Particle by Ink-Jet Method)

Spacer particles were arranged by the following method using spacer particle dispersions S1 to S8, color filter substrates 41, 61, and TFT array model substrates 51 shown in Table 1.

First, an ink-jet device of a piezo ink-jet device, on which a head having a hole diameter of 50 μm was mounted, was prepared. A liquid-contacting portion of an ink chamber of the head comprised a material having the surface tension shown in Table 1. Incidentally, the surface tension of the material (surface) of the liquid-contacting portion was investigated by a method in which contact angles of several kinds of liquids having a known surface tension over the surface of the material were measured to estimate the surface tension at which a contact angle becomes zero.

Next, a color filter substrate 41 or 61 having the steps shown in FIG. 5 was placed on a stage. Onto this color filter substrate 41 or 61, droplets of the spacer particle dispersion shown in Table 1 were ejected at pitches 110 μm longitudinally and 150 μm horizontally at 110 μm gap on a longitudinal every other line aimed at a black matrix 43 using the ink-jet device described above and arranged, and then the arranged droplets were dried on a hot plate heated to 45° C. A gap between the nozzle (head face) and the substrate in ejecting the spacer particle dispersion was set at 0.5 mm and a double pulse system was employed. Further, in only Example 13, drying was performed on the hot plate heated to 120° C.

Further, a TFT array model substrate 51 having the steps 53 shown in FIG. 6 was placed on a stage. Onto this substrate, droplets of the spacer particle dispersion shown in Table 1 were ejected at pitches 110 μm longitudinally and 150 μm horizontally at 110 μm gap on a longitudinal every other line aimed at the step 53 corresponding to the black matrix 43 using the ink-jet device described above and arranged, and then the arranged droplets were dried on a hot plate heated to 45° C. A gap between the nozzle (head face) and the substrate in ejecting the spacer particle dispersion was set at 0.5 mm and a double pulse system was employed. Further, as for drying conditions in Example 13, drying was performed for 10 seconds on the hot plate set at 120° C.

A distribution density of the spacer particles arranged on the substrate, obtained in the manner described above and the average number of spacer particles was measured. And, the above-mentioned ejection onto the substrate was performed after the spacer particle dispersion was introduced into the head, that is, head cleaning was performed by the number of times shown in Table 1, but a ratio of nozzles not ejecting after head cleaning to the total nozzles was also measured. The results of measurements are shown in Table 1 below.

After visually recognizing that the spacer particle dispersion ejected onto the substrate on a stage was completely dried, the remaining solvent was further removed from the dispersion, and the substrate was shifted onto a hot plate heated to 150° C., heated, and allowed to stand for 15 minutes to make the spacer particles fixed to the substrate.

### (Preparation of Liquid Crystal Display Device for Evaluation)

The color filter substrate 41 and the TFT array model substrate 51 to be an opposed substrate, on one of which the spacer particles were arranged in the manner described above, or the color filter substrate 61 and the TFT array model substrate 51 to be an opposed substrate, on one of which the spacer particles were arranged were bonded to each other using a peripheral sealing material. After bonding, the sealing material was cured by heating at 150° C. for 1 hour, and then such an empty cell that a cell gap is equal to a particle diameter of the spacer particle was produced, and next, liquid crystal was filled into the cell by a vacuum method and a filling port was sealed with an end-sealing material to prepare a liquid crystal display.

### (Evaluation of Examples 1 to 13 and Comparative Examples 1 to 4)

The following items were evaluated. The results of evaluation are shown in Table 1.

### (Density of Spacer Particle Distributed)

After fixing the spacer particles to the substrate, number of the spacer particles distributed per 1 mm² was observed and regarded as a density of the spacer particle distributed.

### (Average Number of Spacer Particles)

An average value of the number of spacer particles aggregated in one arrangement position was measured within the area of 1 mm² described above. In addition, in Table 1, a symbol—means that the spacer particles do not aggregate and therefore it is unmeasurable.

### (Arrangement Accuracy of Spacer Particle)

States of arrangement of spacer particles after drying of a droplet were determined according to the following criteria.

### ∘: Almost all spacer particles existed at a specific location (light-blocking area) corresponding to a non-pixel area.

### Δ: A part of spacer particles existed out of a specific location (light-blocking area) corresponding to a non-pixel area.

x: Many spacer particles existed out of a specific location (light-blocking area) corresponding to a non-pixel area.

### (Area of Existence of Spacer Particle)

As shown in FIG. 7, two parallel lines were drawn on both sides of a center line of a black matrix or an area corresponding to the black matrix with equal distance from the center line, and the space between the two parallel lines, between which 95% or more of the number of the spacer particles exist, was regarded as an area of existence of spacer particle.

### (Display Image Quality)

The display image quality of the liquid crystal display device was observed and determined according to the following criteria.

### ∘: There were few spacer particles in the display area and there was no light leakage resulting from the spacer particle.

### Δ: There were a few spacer particles in the display area and there was light leakage resulting from a spacer particle.

x: There were spacer particles in the display area and there was light leakage resulting from a spacer particle.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Spacer | Species | | S1 | S2 | S2 | S3 | S3 | S4 | S5 | S6 | S7 |
| dispersion | Spacer | Species | SA | SB | SB | SB | SB | SC | SC | SC | SC |
| | | Addition amount (g) | 0.25 | 0.25 | 0.25 | 0.25 | 0.25 | 0.25 | 0.25 | 0.25 | 0.25 |
| | Amount of | Ethanol | — | — | — | — | — | — | 5 | — | — |
| | solvent to | 2-propanol | 10 | 10 | 10 | 5 | 5 | 10 | — | 5 | 5 |
| | be mixed | Water | 20 | 20 | 20 | 20 | 20 | 20 | 20 | 20 | 20 |
| | (g) | Ethylene glycol | 70 | 70 | 70 | 75 | 75 | 70 | 75 | — | — |
| | | 1,4-butanediol | — | — | — | — | — | — | — | 75 | — |
| | | Diethylene glycol | — | — | — | — | — | — | — | — | 75 |
| | Surface tension (mN/m) | | 40 | 40 | 40 | 43 | 43 | 40 | 43 | 38 | 39 |
| Head | Material of liquid-contacting portion | | SUS | SUS | cera | SUS | cera | SUS | cera | SUS | SUS |
| | Surface tension of liquid-contacting | | 47 | 47 | 44 | 47 | 44 | 47 | 44 | 47 | 47 |
| | portion (mN/m) | | | | | | | | | | |
| | Number of head-cleanings | | 1 | 1 | 1 | 2 | 2 | 1 | 2 | 1 | 1 |
| | Ratio of nozzles not ejecting (%) | | 0 | 0 | 0 | 0 | 0 | 0 | 0 | 0 | 0 |
| Substrate | Substrate | Species | 41 | 41 | 41 | 41 | 41 | 41 | 41 | 41 | 41 |
| | onto which | Step (μm) | 0 | 0 | 0 | 0 | 0 | 0 | 0 | 0 | 0 |
| | the spacer | | | | | | | | | | |
| | particle | | | | | | | | | | |
| | dispersion | | | | | | | | | | |
| | is ejected | | | | | | | | | | |
| | Opposed | Species | 51 | 51 | 51 | 51 | 51 | 51 | 51 | 51 | 51 |
| | substrate | Step (μm) | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Results | Density of spacer distributed | 190 | 180 | 185 | 203 | 205 | 184 | 200 | 175 | 205 |
| | (piece/mm²) | | | | | | | | | |
| | Average number of spacers | 3.1 | 3.0 | 3.1 | 3.3 | 3.4 | 3.0 | 3.3 | 2.9 | 3.4 |
| | (piece/dot) | | | | | | | | | |
| | Arrangement accuracy of spacer | ∘ | ∘ | ∘ | ∘ | ∘ | ∘ | ∘ | ∘ | ∘ |
| | Area of existence of spacer particle | 23 | 24 | 23 | 18 | 19 | 23 | 21 | 23 | 22 |
| | (μm) | | | | | | | | | |
| | Display image quality | ∘ | ∘ | ∘ | ∘ | ∘ | ∘ | ∘ | ∘ | ∘ |

| | | Example | | | | Comparative Example | | |
|---|---|---|---|---|---|---|---|---|
| | | 10 | 11 | 12 | 13 | 1 | 2 | 3 |
| Spacer | Species | S4 | S4 | S4 | S4 | S3 | S8 | S8 |

| | | | | | | | | | |
|---|---|---|---|---|---|---|---|---|---|
| dispersion | Spacer | Species | SC | SC | SC | SC | SB | SB | SB |
| | | Addition amount (g) | 0.25 | 0.25 | 0.25 | 0.25 | 0.25 | 0.25 | 0.25 |
| | Amount of | Ethanol | — | — | — | — | — | — | — |
| | solvent to | 2-propanol | 10 | 10 | 10 | 10 | 5 | 20 | 20 |
| | be mixed | Water | 20 | 20 | 20 | 20 | 20 | 20 | 20 |
| | (g) | Ethylene glycol | 70 | 70 | 70 | 70 | 75 | 60 | 60 |
| | | 1,4-butanediol | — | — | — | — | — | — | — |
| | | Diethylene glycol | — | — | — | — | — | — | — |

| | | | | | | | | |
|---|---|---|---|---|---|---|---|---|
| | Surface tension (mN/m) | 40 | 40 | 40 | 40 | 43 | 31 | 31 |
| Head | Material of liquid-contacting portion | SUS | SUS | SUS | SUS | PI | PI | SUS |
| | Surface tension of liquid-contacting | 47 | 47 | 47 | 47 | 28 | 28 | 47 |
| | portion (mN/m) | | | | | | | |
| | Number of head-cleanings | 1 | 1 | 1 | 1 | 5 | 2 | 1 |
| | Ratio of nozzles not ejecting (%) | 0 | 0 | 0 | 0 | 50 | 3 | 0 |

| | | | | | | | | | |
|---|---|---|---|---|---|---|---|---|---|
| Substrate | Substrate | Species | 61 | 51 | 51 | 41 | 41 | 41 | 41 |
| | onto which | Step (μm) | 1.3 | 0.2 | 0.2 | 0 | 0 | 0 | 0 |
| | the spacer | | | | | | | | |
| | particle | | | | | | | | |
| | dispersion | | | | | | | | |
| | is ejected | | | | | | | | |
| | Opposed | Species | 51 | 41 | 61 | 51 | 51 | 51 | 51 |
| | substrate | Step (μm) | 0.2 | 0 | 1.3 | 0.2 | 0.2 | 0.2 | 0.2 |

| | | | | | | | | |
|---|---|---|---|---|---|---|---|---|
| Results | Density of spacer distributed | 186 | 187 | 192 | 186 | 95 | 170 | 190 |
| | (piece/mm²) | | | | | | | |
| | Average number of spacers | 3.1 | 3.1 | 3.2 | 3.0 | 1.6 | 2.8 | 3.1 |
| | (piece/dot) | | | | | | | |
| | Arrangement accuracy of spacer | ∘ | ∘ | ∘ | ∘ | Δ | x | x |
| | Area of existence of spacer particle | 22 | 22 | 21 | 20 | 21 | 35 | 35 |
| | (μm) | | | | | | | |
| | Display image quality | ∘ | ∘ | ∘ | ∘ | Δ | x | x |

Material of liquid-contacting portion SUS: stainless steel, cera: ceramic burnt glass, PI: polyimide

And, boiling points, viscosities, and surface tensions of the solvents used in these Examples and Comparative Examples are shown in Table 2 below.

TABLE 2

| | Boiling point | Viscosity | Surface tension |
|---|---|---|---|
| | (° C.) | (mPa · s) | (mN/m) |
| Ethanol | 78 | 1.2 | 22.3 |
| 2-propanol | 82 | 2.4 | 21.7 |
| Water | 100 | 1.0 | 72.6 |
| Ethylene glycol | 198 | 23 | 46.5 |
| 1,4-butanediol | 229 | 88 | 45.3 |
| Diethylene glycol | 245 | 35 | 48.5 |

As shown in Table 1, in the liquid crystal display devices of Examples, the nozzle not ejecting was not produced, and the spacer particles were arranged substantially in a non-display area with high accuracy and the display image quality was excellent. On the other hand, in the liquid crystal display devices of Comparative Examples, the nozzle not ejecting was produced, and spacer particles gathered but were arranged even in a display area with low accuracy and the display image quality was low.

### EXAMPLES 14 TO 36, COMPARATIVE EXAMPLES 4 TO 14

### Preparation of Spacer Particle Dispersion

The spacer particles obtained by the above-mentioned method were taken by an amount required to obtain a given particle concentrations and these spacer particles were gradually added to solvents having the composition shown in Table 3 and Table 4 below and dispersed by being adequately stirred with a sonicater. Thereafter, the resulting spacer particle dispersions were filtrated with a stainless screen with mesh size of 10 μm to remove aggregated matters to obtain spacer particle dispersions.

The surface tension at 20° C. of the obtained spacer particle dispersions was measured by a Wilhelmy method using a platinum plate. Further, the spacer particle dispersion was put into a test tube with an inner diameter φ of 5 mm to the height of 10 cm and left standing, and the time lapsed until the precipitation of the spacer particle dispersion was visually observed at the bottom of the test tube was measured to evaluate a settling speed of the spacer particle dispersion. The results of measurements of surface tension, viscosity, specific gravity and settling speed are shown in Table 3 and Table 4 below.

### (Preparation of Substrate)

A Color Filter Substrate was Used as a First substrate for a liquid crystal test panel and a TFT array model substrate simulating the steps existing on a TFT array substrate was used as a second substrate.

### (Color Filter Substrate)

Color filter substrates 21 having a smooth surface used in Examples and Comparative Examples were prepared in the following manner.

As shown in FIGS. 5(a), 5(b), black matrixes 43 (25 μl in width, pitch of 150 μm in length, pitch of 75 μm in width, 0.2 μm in thickness) comprising metal chromium were provided on a glass substrate 42 having a size of 300 mm×360 mm by a normal method. On and between the black matrixes 43, pixels (thickness 1.5 μm) of a color filter 44, comprising three colors of Red/Green/Blue, were formed in such a way that the surfaces of the pixels are flat. Thereon, an overcoat layer 45 and an ITO transparent electrode 46, which have a substantially uniform thickness, were installed.

Furthermore, onto this, a polyimide resin solution was applied by spin coating. After this application, the spacer particle dispersion was dried at 150° C. and then baked at 230° C. for 1 hour, and cured to form an alignment layer 47 having a substantially uniform thickness. In this time, either of three different polyimide resin solutions shown below was used in order to form either of alignment layers of PI1, PI2 and PI3. Further, the surface tension (γ) of the formed alignment layer is as follows.

### PI1: trade name “SUNEVER SE130”, produced by NISSAN CHEMICAL INDUSTRIES, LTD, surface tension (γ): 46 mN/m

### PI2: trade name “SUNEVER SE150”, produced by NISSAN CHEMICAL INDUSTRIES, LTD, surface tension (γ): 39 mN/m

### PI3: trade name “SUNEVER SE1211”, produced by NISSAN CHEMICAL INDUSTRIES, LTD, surface tension (γ): 26 mN/m

### (TFT Array Model Substrate)

A TFT array model substrate was prepared in the same manner as in Example 1.

### (Ink-Jet Device)

An ink-jet device of a piezo ink-jet device, on which a head (optimum viscosity range at ejection 10 to 20 mPa·s capable of heating) having a hole diameter of 50 μm was mounted, was prepared. A liquid-contacting portion of an ink chamber of the head comprised a glass ceramic material and a nozzle face of fluorine base water repellent finish was used.

Further, on Example 35 and Example 36, an ink-jet device on which a head (optimum viscosity range at ejection 5 to 15 mPa·s incapable of heating) having a nozzle hole diameter of 40 μm was mounted, was prepared.

### (Arrangement of Spacer Particle by Ink-Jet Method)

In these Examples and Comparative Examples, a time from introduction of the spacer particle dispersion into the ink chamber of the ink-jet device to ejection of the spacer particle dispersion was changed. That is, the case where the spacer particle dispersion was ejected soon after it was introduced, and the case where the spacer particle dispersion was left standing for 1 hour after it was introduced and then it was ejected were evaluated. The spacer particles were arranged by the following method using spacer particle dispersions shown in Table 3 and Table 4, the color filter substrate 41, and the TFT array model substrates 51. Further, when the spacer particles were arranged, arrangement of spacer particles was started after 0.5 mL of an initial spacer particle dispersion ejected from the nozzle of the ink-jet device was discard.

First, a color filter substrate 41 having the steps shown in FIG. 5 was placed on a stage (room temperature). Onto this color filter substrate 41, droplets of the spacer particle dispersion shown in Tables 3 and 4 were ejected at pitches 110 μm longitudinally and 150 μm horizontally at 110 μm gap on a longitudinal every other line aimed at the black matrix 43 using the ink-jet device described above and arranged, and then the arranged droplets were dried on a hot plate heated to 45° C. A gap between the nozzle (head face) and the substrate in ejecting the spacer particle dispersion was set at 0.5 mm and a double pulse system was employed.

After visually recognizing that the spacer particle dispersion ejected onto the color filter substrate 41 on a stage was completely dried, the remaining solvent was further removed from the dispersion, and the substrate was shifted onto a hot plate heated to 150° C., heated, and allowed to stand for 15 minutes to make the spacer particles adhere to the substrate. In addition, if the viscosity of the spacer particle dispersion is more than 15 mPa·s when the spacer particle dispersion is ejected as-is, it: was ejected while being heated so that the viscosity becomes 3 to 15 mPa·s.

Further, in Example 35 and Example 36, since the heads which could not be heated were used, the spacer particle dispersions were ejected at room temperature (20° C.).

Further, a TFT array model substrate 51 having the steps 53 shown in FIG. 6 was placed on a stage. Onto this substrate, droplets of the spacer particle dispersion shown in Tables 3 and 4 were ejected at pitches 110 μm longitudinally and 150 μm horizontally at 110 μm gap on a longitudinal every other line aimed at the step 53 corresponding to the black matrix 53 using the ink-jet device described above and arranged, and then the arranged droplets were dried on a hot plate heated to 45° C. A gap between the nozzle (head face) and the substrate in ejecting the spacer particle dispersion was set at 0.5 mm and a double pulse system was employed.

After ejecting, an initial contact angle (θ) and a receding contact angle (θr) of the droplet of the spacer particle dispersion to the substrate were measured with a contact angle meter. The results of measurements are shown in Table 3 and Table 4.

In order to investigate the initial contact angle (θ) and the receding contact angle (θr) of the droplet of the spacer particle dispersion after ejecting to the substrate, the same substrate was separately used. Their contact angles were measured by a common contact angle meter of a type in which after dropping a droplet, this droplet was observed from a side with a magnifying camera to determine a contact angle. By the way, herein, a receding contact angle is obtained by measuring a contact angle exhibited at the time when a droplet of the spacer particle dispersion located on the surface of the substrate becomes smaller than a diameter of a droplet having deposited at the time of being located first on the substrate (the time when a droplet begins to contract) in a process from being located on the substrate to drying.

### (Preparation of Liquid Crystal Display Device for Evaluation)

The color filter substrate 41 and the TFT array model substrate 51 to be an opposed substrate, on one of which the spacer particles were arranged in the manner described above, were bonded to each other using a peripheral sealing material. After bonding, the sealing material was cured by heating at 150° C. for 1 hour, and then such an empty cell that a cell gap is equal to a particle diameter of the spacer particle was produced, and next, liquid crystal was filled into the cell by a vacuum method and a filling port was sealed with an end-sealing material to prepare a liquid crystal display.

### (Evaluation of Examples 14 to 36 and Comparative Examples 4 to 14)

The following items were evaluated. The results of evaluation are shown in Tables 3 and 4.

### (Density of Spacer Particle Distributed)

After fixing the spacer particles to the substrate, number of the spacer particles distributed per 1 mm² was observed and regarded as a density of the spacer particle distributed.

### (Average Number of Spacer Particles)

An average value of the number of spacer particles aggregated in one arrangement position was measured within the area of 1 mm² described above. In addition, in Table 4, a symbol—means that the spacer particles do not aggregate and therefore it is unmeasurable.

### (Arrangement Accuracy of Spacer Particle)

States of arrangement of spacer particles after drying of a droplet were determined according to the following criteria.

### ∘: Almost all spacer particles existed at a specific location (light-blocking area) corresponding to an area defining the pixel area.

### Δ: A part of spacer particles existed out of a specific location (light-blocking area) corresponding to an area defining the pixel area.

x: Many spacer particles existed out of a specific location (light-blocking area) corresponding to an area defining the pixel area.

### (Area of Existence of Spacer Particle)

As shown in FIG. 7, two parallel lines were drawn on both sides of a center line of a black matrix or an area corresponding to the black matrix with equal distance from the center line, and the space between the two parallel lines, between which 95% or more of the number of the spacer particles exist, was regarded as an area of existence of spacer particle.

### (Display Image Quality)

The display image quality of the liquid crystal display device was observed and determined according to the following criteria.

### ∘: There were few spacer particles in the display area and there was no light leakage resulting from the spacer particle.

### Δ: There were a few spacer particles in the display area and there was light leakage resulting from a spacer particle.

x: There were spacer particles in the display area and there was light leakage resulting from a spacer particle.

TABLE 3

| | | Example | | | | | | | |
|---|---|---|---|---|---|---|---|---|---|
| | | 14 | 15 | 16 | 17 | 18 | 19 | 20 | 21 |
| Amount | Ethanol | | | | | | | | |
| of solvent | 2-propanol | 15 | 15 | 15 | 15 | 15 | 15 | 15 | 15 |
| to be | Water | 5 | 5 | 5 | 5 | 5 | 5 | 5 | 5 |
| mixed (g) | Ethylene glycol methyl ether | | | | | | | | |
| | Propylene glycol | | | | | | | | |
| | Ethylene glycol | 80 | 80 | 80 | 80 | 80 | 80 | 80 | 80 |
| | 1,4-butanediol | | | | | | | | |
| | Diethylene glycol | | | | | | | | |
| Spacer species | | SA | SA | SA | SA | SB | SB | SA | SA |
| Particle diameter (μm) | | 4 | 4 | 3 | 5 | 4 | 4 | 4 | 4 |
| Addition amount(g) | | 0.25 | 0.25 | 0.1 | 0.6 | 0.25 | 0.25 | 0.25 | 0.25 |
| Spacer dispersion | Surface tension (mN/m) | 36.8 | 36.8 | 36.3 | 36.5 | 36.6 | 36.7 | 36.8 | 36.8 |
| | Viscosity η 20 (mPa · s) | 14.1 | 14.1 | 13.9 | 14.4 | 14.1 | 14.1 | 14.1 | 14.1 |
| | Specific gravity d20 | 1.044 | 1.044 | 1.043 | 1.044 | 1.044 | 1.044 | 1.044 | 1.044 |
| | (g/cm³) | | | | | | | | |
| Settling speed (min) | | 300 | 300 | 900 | 240 | 300 | 300 | 300 | 300 |
| Substrate onto | Species | 51 | 51 | 51 | 51 | 51 | 51 | 41 | 51 |
| which the spacer | Step (nm) | 5 | 5 | 5 | 5 | 5 | 5 | 0 | 200 |
| particle dispersion | Species of alignment layer | PI2 | PI3 | PI3 | PI3 | PI3 | PI3 | PI3 | PI3 |
| is ejected | Initial contact angle θ (degree) | 32.1 | 44.2 | 44.0 | 45.0 | 43.5 | 44.6 | 44.6 | 44.0 |
| | Receding contact angle θ r (degree) | 17.0 | 45.0 | 42.0 | 44.4 | 44.6 | 45.5 | 42.7 | 43.0 |
| Species of opposed substrate | | 41 | 41 | 41 | 41 | 41 | 41 | 51 | 41 |
| Step (nm) | | 0 | 0 | 0 | 0 | 0 | 0 | 5 | 0 |
| Initial | Density of spacer distributed | 200 | 190 | 190 | 190 | 190 | 190 | 180 | 175 |
| | (piece/mm²) | | | | | | | | |
| | Average number of spacers | 3.3 | 3.1 | 3.1 | 3.1 | 3.1 | 3.1 | 3.0 | 2.9 |
| | (piece/dot) | | | | | | | | |
| 1 hour | State of ejection | ∘ | ∘ | ∘ | ∘ | ∘ | ∘ | ∘ | ∘ |
| later | Density of spacer distributed | 205 | 195 | 195 | 200 | 190 | 200 | 175 | 180 |
| | (piece/mm²) | | | | | | | | |
| | Average number of spacers | 3.4 | 3.2 | 3.2 | 3.3 | 3.1 | 3.3 | 2.9 | 3.0 |
| | (piece/dot) | | | | | | | | |

| | | | | | | | | |
|---|---|---|---|---|---|---|---|---|
| Arrangement accuracy of spacer | ∘ | ∘ | ∘ | ∘ | ∘ | ∘ | ∘ | ∘ |
| Area of existence of spacer particle (μm) | 24 | 22 | 21 | 25 | 24 | 24 | 25 | 20 |
| Display image quality | ∘ | ∘ | ∘ | ∘ | ∘ | ∘ | ∘ | ∘ |

| | | Example | | | | | | | |
|---|---|---|---|---|---|---|---|---|---|
| | | 22 | 23 | 24 | 25 | 26 | 27 | 28 | 29 |
| Amount | Ethanol | 15 | 15 | | | | | | |
| of solvent | 2-propanol | | | 15 | 15 | 10 | | 10 | 15 |
| to be | Water | 5 | 5 | | | | | | 5 |
| mixed (g) | Ethylene glycol methyl ether | | | | | | | | |
| | Propylene glycol | | | | | | | 90 | |
| | Ethylene glycol | 80 | 80 | 85 | 85 | 90 | 100 | | |
| | 1,4-butanediol | | | | | | | | 80 |
| | Diethylene glycol | | | | | | | | |
| Spacer species | | SA | SA | SA | SA | SA | SA | SA | SA |
| Particle diameter (μm) | | 4 | 4 | 4 | 4 | 4 | 4 | 4 | 4 |
| Addition amount(g) | | 0.25 | 0.25 | 0.25 | 0.25 | 0.25 | 0.25 | 0.25 | 0.25 |
| Spacer dispersion | Surface tension (mN/m) | 36.0 | 36.0 | 35.6 | 35.6 | 38.8 | 46.5 | 34.4 | 36.2 |
| | Viscosity η 20 (mPa · s) | 13.7 | 13.7 | 15.7 | 15.7 | 17.5 | 23.0 | 20.0 | 24.2 |
| | Specific gravity d20 | 1.045 | 1.045 | 1.046 | 1.046 | 1.063 | 1.113 | 1.048 | 1.038 |
| | (g/cm³) | | | | | | | | |
| Settling speed (min) | | 300 | 300 | 600 | 600 | 720 | 2400 | 600 | 240 |
| Substrate onto | Species | 51 | 51 | 51 | 51 | 51 | 51 | 51 | 51 |
| which the spacer | Step (nm) | 5 | 5 | 5 | 5 | 5 | 5 | 5 | 5 |
| particle dispersion | Species of alignment layer | PI2 | PI3 | PI2 | PI3 | PI3 | PI3 | PI3 | PI2 |
| is ejected | Initial contact angle θ (degree) | 33.0 | 45.0 | 29.0 | 35.0 | 35.3 | 69.0 | 18.4 | 30.0 |
| | Receding contact angle θ r (degree) | 17.1 | 44.8 | 12.0 | 32.0 | 33.3 | 51.2 | 9.7 | 16.5 |
| Species of opposed substrate | | 41 | 41 | 41 | 41 | 41 | 41 | 41 | 41 |
| Step (nm) | | 0 | 0 | 0 | 0 | 0 | 0 | 0 | 0 |
| Initial | Density of spacer distributed | 190 | 180 | 200 | 190 | 190 | 180 | 210 | 180 |
| | (piece/mm²) | | | | | | | | |
| | Average number of spacers | 3.1 | 3.0 | 3.3 | 3.1 | 3.1 | 3.0 | 3.5 | 3.0 |
| | (piece/dot) | | | | | | | | |
| 1 hour | State of ejection | ∘ | ∘ | ∘ | ∘ | ∘ | ∘ | ∘ | ∘ |
| later | Density of spacer distributed | 185 | 180 | 200 | 185 | 190 | 200 | 200 | 195 |
| | (piece/mm²) | | | | | | | | |
| | Average number of spacers | 3.1 | 3.0 | 3.3 | 3.1 | 3.1 | 3.3 | 3.3 | 3.2 |
| | (piece/dot) | | | | | | | | |

| | | | | | | | | |
|---|---|---|---|---|---|---|---|---|
| Arrangement accuracy of spacer | ∘ | ∘ | ∘ | ∘ | ∘ | ∘ | ∘ | ∘ |
| Area of existence of spacer particle (μm) | 24 | 23 | 24 | 23 | 24 | 25 | 25 | 24 |
| Display image quality | ∘ | ∘ | ∘ | ∘ | ∘ | ∘ | ∘ | ∘ |

| | | Example | | | | | | |
|---|---|---|---|---|---|---|---|---|
| | | 30 | 31 | 32 | 33 | 34 | 35 | 36 |
| Amount | Ethanol | | | | | | | |
| of solvent | 2-propanol | 15 | 10 | 10 | 10 | 10 | 15 | 15 |
| to be | Water | 5 | | | | | 6 | 7 |
| mixed (g) | Ethylene glycol methyl ether | | | | | | | |
| | Propylene glycol | | | | | | | |
| | Ethylene glycol | | | | | | 79 | 78 |
| | 1,4-butanediol | 80 | 90 | 90 | | | | |
| | Diethylene glycol | | | | 90 | 90 | | |
| Spacer species | | SA | SA | SA | SA | SA | SA | SA |
| Particle diameter (μm) | | 4 | 4 | 4 | 4 | 4 | 4 | 4 |
| Addition amount(g) | | 0.25 | 0.25 | 0.25 | 0.25 | 0.25 | 0.25 | 0.25 |
| Spacer dispersion | Surface tension (mN/m) | 36.2 | 37.8 | 37.8 | 38.9 | 38.9 | 36.7 | 36.6 |
| | Viscosity η 20 (mPa · s) | 24.2 | 25.0 | 25.0 | 19.0 | 19.0 | 13.5 | 13.1 |
| | Specific gravity d20 | 1.038 | 1.045 | 1.045 | 1.080 | 1.080 | 1.043 | 1.042 |
| | (g/cm³) | | | | | | | |
| Settling speed (min) | | 240 | 720 | 720 | 900 | 900 | 300 | 300 |
| Substrate onto | Species | 51 | 51 | 51 | 51 | 51 | 51 | 51 |
| which the spacer | Step (nm) | 5 | 5 | 5 | 5 | 5 | 5 | 5 |
| particle dispersion | Species of alignment layer | PI3 | PI2 | PI3 | PI2 | PI3 | PI3 | PI3 |
| is ejected | Initial contact angle θ (degree) | 42.1 | 21.4 | 25.8 | 22.2 | 24.3 | 44.0 | 45.2 |
| | Receding contact angle θ r (degree) | 44.0 | 10.2 | 18.1 | 9.8 | 20.0 | 44.0 | 42.0 |
| Species of opposed substrate | | 41 | 41 | 41 | 41 | 41 | 41 | 41 |
| Step (nm) | | 0 | 0 | 0 | 0 | 0 | 0 | 0 |
| Initial | Density of spacer distributed | 200 | 180 | 200 | 190 | 180 | 180 | 200 |
| | (piece/mm²) | | | | | | | |
| | Average number of spacers | 3.3 | 3.0 | 3.3 | 3.1 | 3.0 | 3.0 | 3.3 |
| | (piece/dot) | | | | | | | |
| 1 hour | State of ejection | ∘ | ∘ | ∘ | ∘ | ∘ | ∘ | ∘ |
| later | Density of spacer distributed | 205 | 180 | 200 | 185 | 190 | 170 | 180 |
| | (piece/mm²) | | | | | | | |
| | Average number of spacers | 3.4 | 3.0 | 3.3 | 3.1 | 3.1 | 2.8 | 3.0 |
| | (piece/dot) | | | | | | | |

| | | | | | | | |
|---|---|---|---|---|---|---|---|
| Arrangement accuracy of spacer | ∘ | ∘ | ∘ | ∘ | ∘ | ∘ | ∘ |
| Area of existence of spacer particle (μm) | 23 | 24 | 23 | 22 | 22 | 22 | 22 |
| Display image quality | ∘ | ∘ | ∘ | ∘ | ∘ | ∘ | ∘ |

TABLE 4

| | | Comparative Example | | | | | | | | | | |
|---|---|---|---|---|---|---|---|---|---|---|---|---|
| | | 4 | 5 | 6 | 7 | 8 | 9 | 10 | 11 | 12 | 13 | 14 |
| Amount | Ethanol | | | | | | | | | | | |
| of solvent | 2-propanol | 10 | 10 | | 15 | 10 | 15 | 15 | 15 | 15 | 15 | 15 |
| to be | Water | | | | 75 | 40 | 15 | 15 | 15 | 85 | 85 | 85 |
| mixed (g) | Ethylene glycol | | | | 10 | | | | | | | |
| | methyl ether | | | | | | | | | | | |
| | Propylene glycol | | 90 | 100 | | | | | | | | |
| | Ethylene glycol | 90 | | | | 50 | 70 | 70 | 70 | | | |
| | 1,4-butanediol | | | | | | | | | | | |
| | Diethylene glycol | | | | | | | | | | | |
| Spacer species | | SA | SA | SA | SA | SA | SA | SA | SA | SA | SA | SA |
| Particle diameter (μm) | | 4 | 4 | 4 | 4 | 4 | 4 | 4 | 4 | 4 | 4 | 4 |
| Addition amount(g) | | 0.25 | 0.25 | 0.25 | 0.25 | 0.25 | 0.25 | 0.25 | 0.25 | 0.25 | 0.25 | 0.25 |
| Spacer | Surface tension (mN/m) | 38.8 | 34.4 | 38.0 | 34.2 | 37.2 | 37.5 | 37.5 | 37.5 | 35.0 | 35.0 | 35.0 |
| dispersion | Viscosity η 20 (mPa · s) | 17.5 | 20.0 | 56.0 | 2.3 | 5.4 | 10.0 | 10.0 | 10.0 | 2.3 | 2.3 | 2.3 |
| | Specific | 1.063 | 1.048 | 1.040 | 0.962 | 1.018 | 1.037 | 1.037 | 1.037 | 0.967 | 0.967 | 0.967 |
| | gravity d20 | | | | | | | | | | | |
| | (g/cm³) | | | | | | | | | | | |
| Settling speed (min) | | 720 | 600 | 2400 | 20 | 60 | 120 | 120 | 120 | 20 | 20 | 20 |
| Substrate | Species | 15 | 15 | 15 | 15 | 15 | 15 | 15 | 15 | 15 | 15 | 15 |
| onto which | Step (nm) | 5 | 5 | 5 | 5 | 5 | 5 | 5 | 5 | 5 | 5 | 5 |
| the spacer | Species of alignment | PI1 | PI1 | PI2 | PI3 | PI1 | PI1 | PI2 | PI3 | PI1 | PI2 | PI3 |
| particle | layer | | | | | | | | | | | |
| dispersion | Initial contact angle | 17.9 | 24.2 | 31.1 | 35.3 | 33.4 | 28.5 | 34.5 | 47.2 | 32.4 | 47.5 | 54.7 |
| is ejected | θ (degree) | | | | | | | | | | | |
| | Receding contact angle | <5 | <5 | <5 | <5 | <5 | <5 | 18.2 | 42.4 | 10.0 | 25.8 | 42.5 |
| | θ r (degree) | | | | | | | | | | | |
| Species of opposed substrate | | 14a | 14a | 14a | 14a | 14a | 14a | 14a | 14a | 14a | 14a | 14a |
| Step (nm) | | 0 | 0 | 0 | 0 | 0 | 0 | 0 | 0 | 0 | 0 | 0 |
| Initial | Density of spacer | 200 | 185 | 190 | 195 | 185 | 190 | 190 | 175 | 180 | 190 | 175 |
| | distributed | | | | | | | | | | | |
| | (piece/mm²) | | | | | | | | | | | |
| | Average number | — | — | — | — | — | — | 3.1 | 2.9 | 3.0 | 3.1 | 2.9 |
| | of spacers | | | | | | | | | | | |
| | (piece/dot) | | | | | | | | | | | |
| 1 hour | State of ejection | ∘ | ∘ | ∘ | x | x | Δ | Δ | Δ | x | x | x |
| later | Density of spacer | 205 | 200 | 200 | 100 | 80 | 150 | 130 | 120 | 40 | 20 | 55 |
| | distributed | | | | | | | | | | | |
| | (piece/mm²) | | | | | | | | | | | |
| | Average number | — | — | — | — | — | — | 2.1 | 2.0 | 0.7 | 0.3 | 0.9 |
| | of spacers | | | | | | | | | | | |
| | (piece/dot) | | | | | | | | | | | |

| | | | | | | | | | | | |
|---|---|---|---|---|---|---|---|---|---|---|---|
| Arrangement accuracy of spacer | x | x | x | x | x | x | ∘ | ∘ | ∘ | ∘ | ∘ |
| Area of existence of spacer particle (μm) | 60 | 68 | 72 | 74 | 44 | 48 | 24 | 23 | 25 | 23 | 20 |
| Display image quality | x | x | x | x | x | x | ∘ | ∘ | ∘ | ∘ | ∘ |

And, boiling points, viscosities, and surface tensions of the solvents used in these Examples and Comparative Examples are shown in Table 5 below.

TABLE 5

| | | | | | Receding contact angle θ r | | |
|---|---|---|---|---|---|---|---|
| | Solvent properties | | | | (degree) | | |
| | Boiling | Surface | Viscosity | Specific | PI1 | PI2 | PI3 |
| | point bp | tension γ | η₂₀ | gravity d₂₀ | (alignment | (alignment | (alignment |
| | ° C. | mN/m | mPa · s | g/cm³ | layer) | layer) | layer) |
| Ethanol | 78 | 22.3 | 1.2 | 0.789 | 0 | 0 | 0 |
| 2-propanol | 82 | 21.7 | 2.4 | 0.786 | 0 | 0 | 0 |
| Water | 100 | 72.6 | 1.0 | 0.998 | 15 | 30 | 57 |
| Ethylene glycol | 125 | 31.8 | 2.1 | 0.929 | 0 | 0 | 0 |
| methyl ether | | | | | | | |
| Propylene glycol | 187 | 38.0 | 56.0 | 1.040 | 0 | <5 | 13 |
| Ethylene glycol | 198 | 46.5 | 23.0 | 1.113 | 0 | 15 | 51 |
| 1,4-butanediol | 229 | 45.3 | 88.8 | 1.015 | 0 | 11 | 35 |
| Diethylene glycol | 245 | 48.5 | 35.7 | 1.118 | 0 | 14 | 33 |

As shown in Table 3, in the liquid crystal display devices of Examples, the nozzle not ejecting was not produced, the density of spacers distributed did not change with time, and the spacer particles were arranged substantially in a non-display area with high accuracy and the display image quality was excellent.

On the other hand, as shown in Table 4, in the liquid crystal display devices of Comparative Examples, the nozzle not ejecting was produced, the density of spacers distributed changed with time, and the spacer particles gathered but were arranged even in a display area with low accuracy and the display image quality was low.

### EXAMPLES 37 TO 46, COMPARATIVE EXAMPLES 15 TO 20

### Preparation of Spacer Particle Dispersion

For all solvents for preparing the spacer particle dispersion, the solvents in electronic industries gradings were used. The preparation of the spacer particle dispersion was conducted in a clean room (class 10000).

The spacer particles obtained by the above-mentioned method were taken by an amount required to obtain a given particle concentrations and these spacer particles were gradually added to solvents having the compositions shown in Table 6 and Table 7 below and dispersed by being adequately stirred with a sonicater. Thereafter, the resulting spacer particle dispersions were filtrated with a stainless screen with mesh size of 10 μm to remove aggregated matters to obtain spacer particle dispersions.

Next, in each of Examples 37 to 46 shown in Table 6 below, the spacer particle dispersion was filtrated with a filter having a filter pore diameter through which the spacer particle can pass. Next, in order to remove dust particles/dust substance of non-volatile components, centrifugal precipitation was performed and then supernatant liquid was discarded. This precipitation was dispersed in a solvent having the composition described in the following Table 6 filtrated with a filter with pore size of 0.1 μm. This operation was repeated. The obtained spacer particle dispersions S9 to S18, from which the non-volatile components are removed, were placed in a borosilicate glass-1 container.

On one hand, in the spacer particle dispersion of Comparative Example 15 shown in Table 7 below, the same operations as those performed in Examples 37 to 46 describe above were performed. The obtained spacer particle dispersion S19, from which the non-volatile components are removed, was placed in an alkali(soda) glass-1 container.

On the other hand, in the spacer particle dispersions of Comparative Examples 16 to 20 shown in Table 7 below, the same operations as those performed in Examples 37 to 46 describe above were not performed and the non-volatile components are not removed. The obtained spacer particle dispersions S20 to S24 were placed in a borosilicate glass-1 container.

The surface tension of the obtained spacer particle dispersions S9 to S24 was measured by a Wilhelmy method using a platinum plate. The results of measurements of surface tension, viscosity, specific gravity and settling speed are shown in Tables 6 and 7 below.

### (Preparation of Substrate)

A liquid crystal display device substrate (TFT array model substrate) simulating the steps existing on a TFT array substrate was used as a first substrate for a liquid crystal test panel and a color filter substrate was used as a second substrate.

### (Color Filter Substrate)

Color filter substrates used in Examples and Comparative Examples are shown as a plan view in FIG. 5(a) and as a front sectional view in FIG. 5(b). Color filter substrates 41 having a smooth surface were prepared in the following manner.

As shown in FIGS. 5(a), 5(b), black matrixes 43 (25 μm in width, pitch of 150 μm in length, pitch of 75 μm in width, 0.2 μm in thickness) comprising metal chromium were provided on a glass substrate 42 by a normal method. On and between the black matrixes 43, pixels (thickness 1.5 μm) of a color filter 44, comprising three colors of Red/Green/Blue, were formed in such a way that the surfaces of the pixels are flat. Thereon, an overcoat layer 45 and an ITO transparent electrode 46, which have a substantially uniform thickness, were installed.

Furthermore, onto this, a polyimide resin solution (produced by NISSAN CHEMICAL INDUSTRIES, LTD, “SUNEVER SE1211”) was applied uniformly by spin coating method. After this application, the spacer particle dispersion was dried at 80° C. and then baked at 190° C. for 1 hour, and cured to form an alignment layer (PI2) 47 having a substantially uniform thickness. The surface tension (γ) of the formed alignment layer (PI2) 47 was 39 mN/m.

### (TFT Array Model Substrate)

TFT array model substrates provided with steps, which are shown as a plan view in FIG. 6(a) and as a front view in FIG. 6(b), were prepared in the following manner.

As shown in FIG. 6(a), 6(b), in the TFT array model substrates 51, steps 53 (8 μm in width, 5 nm in elevation) formed from copper were provided at the positions, corresponding to black matrixes 43 of the above-mentioned color filter substrate 41, on a glass substrate 52 by a publicly known method. Thereon, an ITO transparent electrode 54 having a substantially uniform thickness was installed, and furthermore, an alignment layer 55 having a substantially uniform thickness was formed by the method described above. Further, in the TFT array model substrates 51, the alignment layer 55 was formed using a polyimide resin solution similar to an opposed substrate.

### (Ink-Jet Device)

An ink-jet device of a piezo ink-jet device, on which a head having a hole diameter of 50 μm was mounted, was prepared. A liquid-contacting portion of an ink chamber of the head comprised a glass ceramic material and fluorine base water repellent finish was applied to a nozzle face.

### (Arrangement of Spacer Particle by Ink-Jet Method)

Spacer particles were arranged on the TFT array model substrates 51 by the following method using spacer particle dispersions S9 to S17 shown in the following Tables 6 and 7. Further, when the spacer particles were arranged, arrangement of spacer particles was started after 0.5 mL of an initial spacer particle dispersion ejected from the nozzle of the ink-jet device was discarded.

First, a TFT array model substrate 51 having the steps 53 shown in FIG. 6 was placed on a stage. Onto this substrate, droplets of the spacer particle dispersion shown in Table 1 were ejected at pitches 110 μm longitudinally and 150 μm horizontally at 110 μm gap on a longitudinal every other line aimed at the step 53 corresponding to the black matrix 43 using the ink-jet device described above and arranged, and then the arranged droplets were dried on a hot plate heated to 45° C. A gap between a nozzle tip and the substrate in ejecting the spacer particle dispersion was set at 0.5 mm and a double pulse system was employed.

After ejecting, an initial contact angle (θr) and a receding contact angle (θr) of the droplet of the spacer particle dispersion over the substrate were measured with a contact angle meter. The results of measurements are shown in Tables 6 and Table 7.

### (Preparation of Liquid Crystal Display Device for Evaluation)

The TFT array model substrate 51 on which the spacer particles were arranged in the manner described above and the color filter substrate 41 to be an opposed substrate were bonded to each other using a peripheral sealing material. After bonding, the sealing material was cured by heating at 150° C. for 1 hour, and then such an empty cell that a cell gap is equal to a particle diameter of the spacer particle was produced, and next, liquid crystal was filled into the cell by a vacuum method and a filling port was sealed with an end-sealing material to prepare a liquid crystal display.

### (Evaluation of Examples 37 to 46 and Comparative Examples 15 to 20)

The following items were evaluated. The results of evaluation are shown in Tables 6 and 7.

### (Rate of Change of Volume Resistivity of Liquid Crystal)

0.5 g of each of the spacer particle dispersions S9 to S24 was put into a sample bottle and dried under a vacuum at 90° C. for 5 hours and solidified. Thereafter, 0.5 g of liquid crystal (CHISSO LIXON JC5007XX) was put into the sample bottle and left standing at room temperature for 12 hours.

Thereafter, the volume resistivity was measured under the conditions of 5 V, 25° C. using a specific resistance measuring apparatus manufactured by TOYO Corporation, and the rate of change of volume resistivity was determined according to the following equation (2).

rate of change of volume resistivity=(volume resistivity of liquid crystal after a test)/(volume resistivity of liquid crystal before a test)×100(%) (2)

### (Change of a Nematic-Isotropic Phase Transition Temperature of Liquid Crystal)

0.5 g of the spacer particle dispersion obtained in the above-mentioned preparation of spacer particle dispersion was put into a sample bottle and dried under a vacuum at 90° C. for 5 hours and solidified. Thereafter, 0.5 g of liquid crystal (CHISSO LIXON JC5007XX) was put into the sample bottle and left standing at room temperature for 12 hours.

Thereafter, a nematic-isotropic phase transition temperature was measured while scanning at a speed of 10° C./min in a temperature range of 0 to 110° C. using a differential scanning calorimeter (DSC), and changes of a nematic-isotropic phase transition temperature (i.e. a change of NI point of liquid crystal (° C.)) was determined according to the following equation (3).

Change of a nematic-isotropic phase transition temperature of liquid crystal=(Nematic-isotropic phase transition temperature of liquid crystal before a test)−(Nematic-isotropic phase transition temperature of liquid crystal after a test) (3)

### (Content of Non-Volatile Component)

200 g of each of the spacer particle dispersions S9 to S24 was subjected to a centrifugal operation at a low rotational speed of 2500 rpm for 3 minutes to precipitate most of the spacer particles, and then a first supernatant liquid was taken. Thereafter, a solvent composition of the spacer particle dispersion shown in Tables 6 and 7 below was added to the precipitated spacer particle to disperse the spacer particles in the solvent well by ultrasonic action. Next, the same operations were repeated again to take a second supernatant. Thereafter, the second supernatant was added to the first supernatant.

Next, the first supernatant liquid and the second supernatant liquid were filtrated using a filter made of fluororesin, which has a filter pore diameter of 1 μm smaller than the spacer particle. Thereafter, the supernatant liquid which has passed through the filter made of fluororesin, having a filter pore diameter of 1 μm without being separated was dried and solidified. After drying and solidifying, weight of a dried and solidified substance was measured to determine the content of the non-volatile components existing in 100% by weight of the spacer particle dispersions S9 to S24.

Further, a sample in which the non-volatile components were present was observed, and consequently small particles considered to be related to the dust in the air, pieces peeled off from the surface of the spacer particle, crushed pieces of the spacer particle, and solid matter indefinite in shape considered to be homopolymers, monomers and oligomers derived from the surface modification treatment of the spacer particle were recognized.

### (Density of Spacer Particle Distributed)

After fixing the spacer particles to the substrate, number of the spacer particles distributed per 1 mm² was observed and regarded as a density of the spacer particle distributed.

### (Average Number of Spacer Particles)

An average value of the number of spacer particles gathered in one arrangement position was measured within the area of 1 mm² described above. In addition, in Table 6, a symbol—means that the spacer particles do not gather and therefore it is unmeasurable.

### (Arrangement Accuracy of Spacer Particle)

States of arrangement of spacer particles after drying of a droplet were determined according to the following criteria.

### ∘: Almost all spacer particles existed at a specific location (light-blocking area) corresponding to a non-pixel area.

### Δ: A part of spacer particles existed out of a specific location (light-blocking area) corresponding to a non-pixel area.

x: Many spacer particles existed out of a specific location (light-blocking area) corresponding to a non-pixel area.

### (Area of Existence of Spacer Particle)

As shown in FIG. 7, two parallel lines were drawn on both sides of a center line of a black matrix or an area corresponding to the black matrix with equal distance from the center line, and the space between the two parallel lines, between which 95% or more of the number of the spacer particles exist, was regarded as an area of existence of spacer particle.

### (Display Image Quality)

### (1.) Evaluation of Light Leakage

The display image quality of the liquid crystal display device was observed and determined according to the following criteria.

### ∘: There were few spacer particles in the display area and there was no light leakage resulting from the spacer particle.

### Δ: There were a few spacer particles in the display area and there was light leakage resulting from a spacer particle.

x: There were spacer particles in the display area and there was light leakage resulting from a spacer particle.

### (2) Voltage Retention and (3) Residual DC Voltage

A substrate of 50 mm×50 mm, patterned with an ITO transparent electrode was prepared. An alignment layer was formed on this substrate using a polyimide solution (produced by NISSAN CHEMICAL INDUSTRIES, LTD, SUNEVER SE7492).

Thereafter, the spacer particles were arranged according to the above step procedure using an ink-jet device.

Next, the substrate on which the spacer particles were arranged and the other substrate on which the spacer particles were not arrange were bonded to each other using a sealing material (MITSHI CHEMICALS STRUCTBOND XN-21-S), and the sealing material was cured. Next, liquid crystal (CHISSO LIXON JC5007) was filled under a vacuum to prepare cells for evaluations.

The voltage retention and the residual DC voltage of the prepared cells for evaluations were measured under the following conditions using LC Material Characteristics Measurement System Model 6254 (manufactured by TOYO Corporation).

VHR: a voltage after holding 60 μs 5V for 16.61 msec was measured (ratio)

RDC: a voltage between the substrates was measured after a lapse of 10 minutes from an application of 5 V for 1 hour and a short circuit for 1 second

In the above-mentioned evaluations of the voltage retention and the residual DC voltage, in the TFT array model fabricated, when the voltage retention is less than 90%, a problem that the liquid crystal drive voltage of a panel varies when an actual liquid crystal panel is fabricated may arise.

Moreover, in the TFT array model, when the residual DC voltage is more than 200 mV, image retention may be generated in a panel when an actual liquid crystal panel is fabricated.

TABLE 6

| | | Example | | | | | | | | | |
|---|---|---|---|---|---|---|---|---|---|---|---|
| | | 37 | 38 | 39 | 40 | 41 | 42 | 43 | 44 | 45 | 46 |
| Amount of | Ethanol | — | — | — | — | — | — | — | — | — | 15 |
| solvent to | 2-propanol | 15 | 10 | 15 | 15 | 15 | 15 | 15 | 15 | 15 | — |
| be mixed (g) | Water | 85 | — | 15 | 15 | 15 | 15 | 15 | 15 | 5 | 5 |
| | Ethylene glycol | — | 90 | 70 | 70 | 70 | 70 | 70 | 70 | 80 | 80 |
| Spacer | Species | SA | SA | SA | SB | SC | SD | SA | SA | SA | SA |
| particle | Particle diameter (μm) | 4 | 4 | 4 | 4 | 4 | 4 | 3 | 5 | 4 | 4 |
| | Addition amount (g) | 0.25 | 0.25 | 0.25 | 0.25 | 0.25 | 0.25 | 0.1 | 0.6 | 0.25 | 0.25 |
| Spacer | Species | S9 | S10 | S11 | S12 | S13 | S14 | S15 | S16 | S17 | S18 |
| particle | Surface tension | 35.0 | 38.8 | 37.5 | 37.5 | 37.5 | 37.5 | 37.5 | 37.5 | 36.8 | 36.0 |
| | γ₂₀ (mN/m) | | | | | | | | | | |
| dispersion | Viscosity | 2.3 | 17.5 | 10.0 | 10.0 | 10.0 | 10.0 | 10.0 | 10.0 | 14.1 | 13.7 |
| | η₂₀ (mPa · s) | | | | | | | | | | |
| | Specific gravity | 0.967 | 1.063 | 1.037 | 1.037 | 1.037 | 1.037 | 1.037 | 1.037 | 1.044 | 1.045 |
| | d₂₀ (g/cm³) | | | | | | | | | | |
| Rate of change of volume resistivity | | 35 | 40 | 20 | 80 | 50 | 46 | 58 | 84 | 55 | 45 |
| of liquid crystal (%) | | | | | | | | | | | |
| Change of NI point of liquid | | 0.1 | 0.1 | 0.0 | 0.2 | 0.1 | 0.1 | 0.0 | 0.1 | 0.2 | 0.0 |
| crystal (° C.) | | | | | | | | | | | |
| Non-volatile component (wt %) | | <0.001 | <0.001 | <0.001 | <0.001 | <0.001 | <0.001 | <0.001 | <0.001 | <0.001 | <0.001 |
| Substrate onto | Species | 51 | 51 | 51 | 51 | 51 | 51 | 51 | 51 | 51 | 51 |
| which the spacer | Step (nm) | 5 | 5 | 5 | 5 | 5 | 5 | 5 | 5 | 5 | 5 |
| particle dispersion | Species of alignment layer | PI2 | PI2 | PI2 | PI2 | PI2 | PI2 | PI2 | PI2 | PI2 | PI2 |
| is ejected | Initial contact angle | 47.5 | 26.9 | 34.5 | 33.8 | 34.0 | 33.5 | 35.5 | 34.6 | 33.0 | 31.0 |
| | θ (degree) | | | | | | | | | | |
| | Receding contact angle | 25.8 | 14.4 | 18.2 | 18.0 | 19.0 | 17.2 | 18.8 | 18.4 | 18.0 | 18.7 |
| | θ r (degree) | | | | | | | | | | |
| Opposed | Species | 41 | 41 | 41 | 41 | 41 | 41 | 41 | 41 | 41 | 41 |
| substrate | Step (nm) | 0 | 0 | 0 | 0 | 0 | 0 | 0 | 0 | 0 | 0 |
| Density of spacer distributed (piece/mm²) | | 190 | 200 | 190 | 190 | 190 | 195 | 220 | 170 | 190 | 180 |
| Average number of spacers (piece/dot) | | 3.1 | 3.3 | 3.1 | 3.1 | 3.1 | 3.2 | 3.6 | 2.8 | 3.1 | 3.0 |
| Arrangement accuracy of spacer | | ∘ | ∘ | ∘ | ∘ | ∘ | | | | | |
| Area of existence of spacer particle (μm) | | 23 | 25 | 24 | 24 | 24 | 22 | 21 | 25 | 22 | 25 |
| Reliability of | Light leakage evaluation | ∘ | ∘ | ∘ | ∘ | ∘ | | | | | |
| display | Voltage retention (%) | 98 | 97 | 97 | 96 | 98 | 96 | 99 | 97 | 97 | 97 |
| image quality | Residual DC voltage (mV) | 160 | 140 | 100 | 140 | 150 | 150 | 120 | 120 | 140 | 120 |

TABLE 7

| | | Comparative Example | | | | | |
|---|---|---|---|---|---|---|---|
| | | 15 | 16 | 17 | 18 | 19 | 20 |
| Amount of | Ethanol | — | — | — | — | — | — |
| solvent to | 2-propanol | 15 | 10 | 15 | 15 | 15 | 15 |
| be mixed (g) | Water | 15 | — | 15 | 15 | 15 | 15 |
| | Ethylene glycol | 70 | 90 | 70 | 70 | 70 | 70 |
| Spacer | Species | SA | SA | SA | SB | SC | SD |
| particle | Particle diameter (μm) | 4 | 4 | 4 | 4 | 4 | 4 |
| | Addition amount (g) | 0.25 | 0.25 | 0.25 | 0.25 | 0.25 | 0.25 |
| Spacer | Species | S19 | S20 | S21 | S22 | S23 | S24 |
| particle | Surface tension γ₂₀ (mN/m) | 37.5 | 38.8 | 37.5 | 37.5 | 37.5 | 37.5 |
| dispersion | Viscosity η₂₀ (mPa · s) | 10.0 | 17.5 | 10.0 | 10.0 | 10.0 | 10.0 |
| | Specific gravity d₂₀ (g/cm³) | 1.037 | 1.063 | 1.037 | 1.037 | 1.037 | 1.037 |
| Rate of change of volume resistivity of liquid crystal | | 0.25 | 0.40 | 0.55 | 0.70 | 0.50 | 2.00 |
| (%) | | | | | | | |
| Change of NI point of liquid crystal (° C.) | | 0.0 | 0.5 | 0.4 | 0.2 | 0.1 | 1.1 |
| Non-volatile component (wt %) | | <0.001 | 0.002 | 0.003 | 0.002 | 0.002 | 0.002 |
| Substrate onto | Species | 51 | 51 | 51 | 51 | 51 | 51 |
| which the spacer | Step (nm) | 5 | 5 | 5 | 5 | 5 | 5 |
| particle dispersion | Species of alignment layer | PI2 | PI2 | PI2 | PI2 | PI2 | PI2 |
| is ejected | Initial contact angle θ (degree) | 34.5 | 26.9 | 34.5 | 33.8 | 34.0 | 33.5 |
| | Receding contact angle θ r (degree) | 18.2 | 14.4 | 18.2 | 18.0 | 19.0 | 17.2 |
| Opposed | Species | 41 | 41 | 41 | 41 | 41 | 41 |
| substrate | Step (nm) | 0 | 0 | 0 | 0 | 0 | 0 |
| Density of spacer distributed (piece/mm²) | | 190 | 200 | 190 | 190 | 190 | 195 |
| Average number of spacers (piece/dot) | | 3.1 | 3.3 | 3.1 | 3.1 | 3.1 | 3.2 |
| Arrangement accuracy of spacer | | ∘ | ∘ | ∘ | ∘ | ∘ | ∘ |
| Area of existence of spacer particle (μm) | | 24 | 23 | 24 | 22 | 24 | 22 |
| Reliability of | Light leakage evaluation | ∘ | ∘ | ∘ | ∘ | ∘ | ∘ |
| display | Voltage retention (%) | 86 | 88 | 89 | 84 | 82 | 91 |
| image quality | Residual DC voltage (mV) | 260 | 270 | 300 | 240 | 250 | 300 |

Boiling points, viscosities, and surface tensions of the solvents used in these Examples and Comparative Examples are shown in Table 8.

TABLE 8

| | Solvent properties | | | | |
|---|---|---|---|---|---|
| | Boiling | Surface | Viscosity | Specific | |
| | point bp | tension γ | η₂₀ | gravity d₂₀ | Receding contact angle θ r |
| | ° C. | mN/m | mPa · s | g/cm³ | Alignment layer PI2 |
| Ethanol | 78 | 22.3 | 1.2 | 0.789 | 0 |
| 2-propanol | 82 | 21.7 | 2.4 | 0.786 | 0 |
| Water | 100 | 72.6 | 1.0 | 0.998 | 30 |
| Ethylene glycol | 198 | 46.5 | 23.0 | 1.113 | 15 |

As is apparent from Table 6, the liquid crystal display devices obtained in Examples had excellent display image quality.

### INDUSTRIAL APPLICABILITY

In accordance with the present invention, it is possible to provide a method for producing a liquid crystal display device which comprises a step of arranging spacer particles on the surface of a substrate using an ink-jet device, and particularly to a method for producing a liquid crystal display device in which a spacer particle dispersion is improved, a spacer particle dispersion, and a liquid crystal display device.

### BRIEF DESCRIPTION OF THE DRAWINGS

FIG. 1 is a front sectional view showing schematically a liquid crystal display device obtained by a method for producing a liquid crystal display device of an embodiment of the present invention.

FIG. 2 is a schematic view showing a state in which a droplet is ejected from an ink-jet nozzle, wherein (a) shows a case of a nonaxisymmetric meniscus and (b) shows a case of an axisymmetric meniscus.

FIGS. 3(a) to 3(h) is a schematic view showing examples of step portions provided on the surface of a substrate.

FIG. 4 is a schematic view showing a position where spacer particles remain.

FIGS. 5(a), 5(b) and 5(c) are a plan view and a front sectional view showing schematically color filter substrates used in Examples and Comparative Examples.

FIGS. 6(a) and 6(b) are a plan view and a front view showing schematically TFT array model substrates used in Examples and Comparative Examples.

FIG. 7 is a schematic view showing a evaluation method of an area of existence of spacer particles.

FIGS. 8(a) and 8(b) are a partially broken perspective view showing schematically a structure of an example of an ink-jet head and a partially broken perspective view showing a cross section at a nozzle hole section, respectively.

FIG. 9 is a front sectional view showing schematically a conventional liquid crystal display device.

FIG. 10 is a schematic view showing a state in which a spacer particle dispersion is ejected onto a substrate and dried to be arranged.

FIG. 11 is a schematic view showing a state in which a spacer particle dispersion is ejected onto a substrate and dried to be arranged.

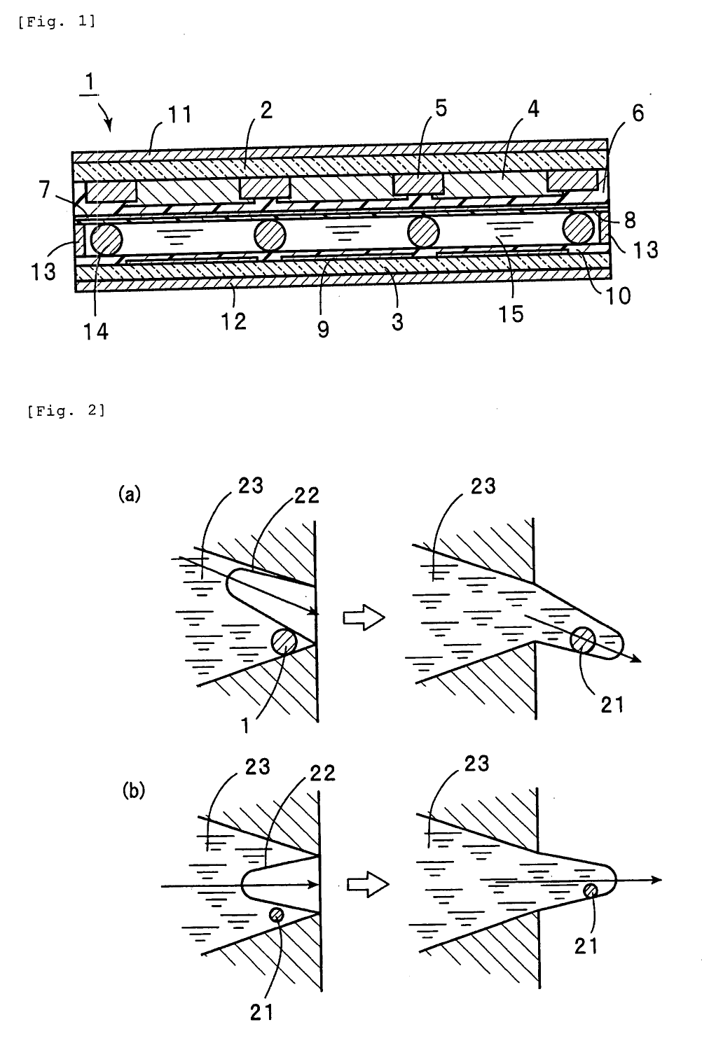

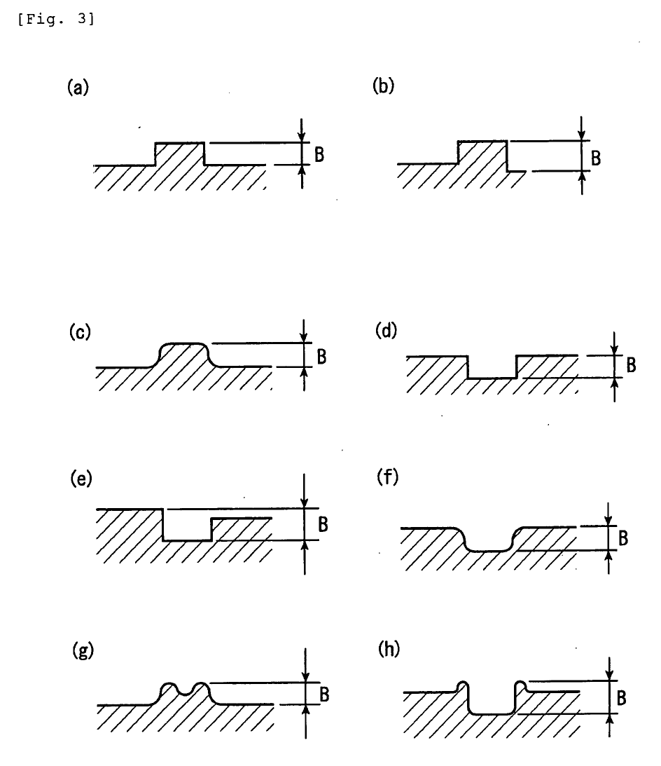

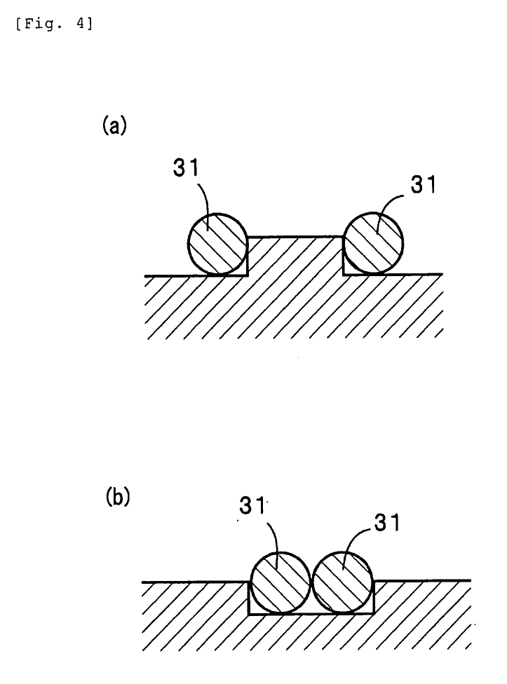

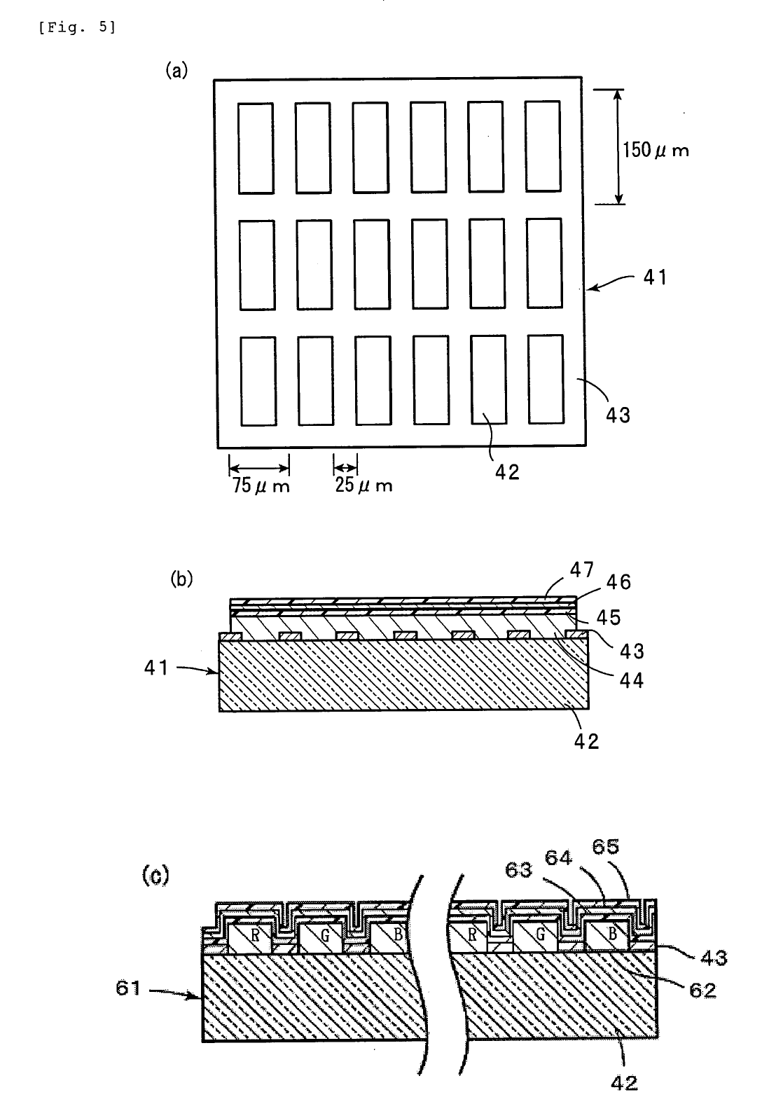

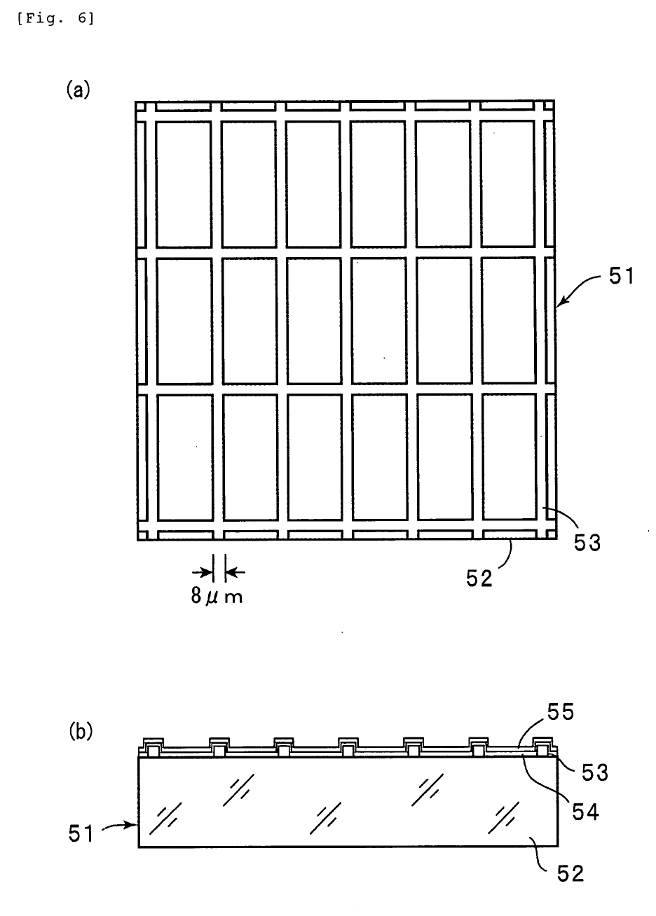

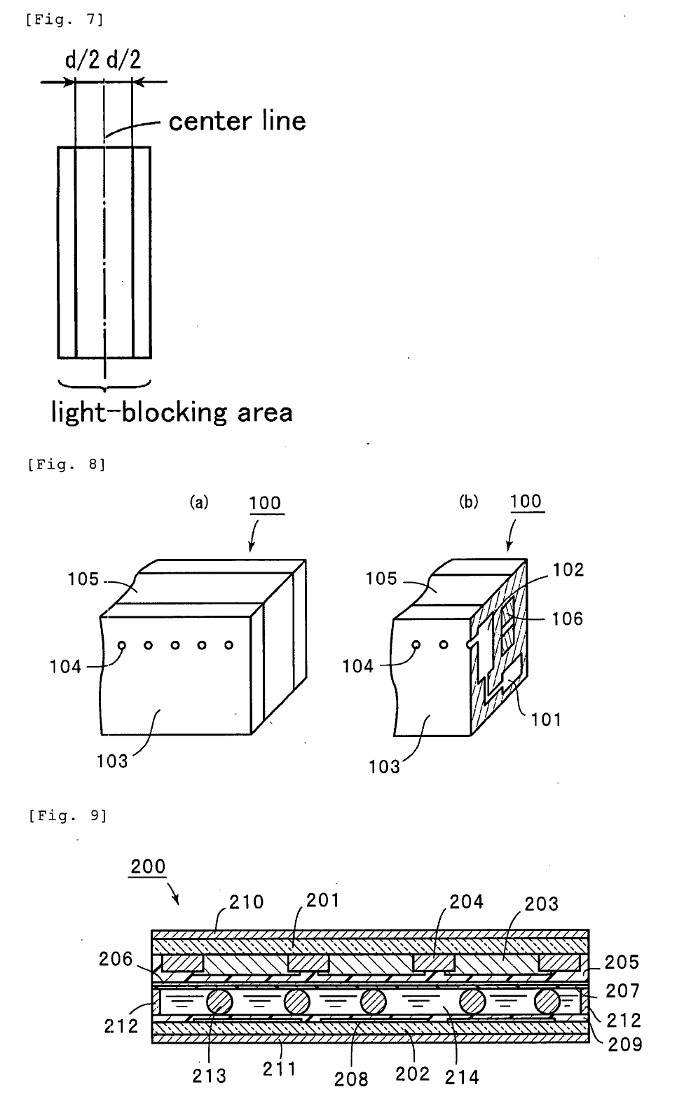

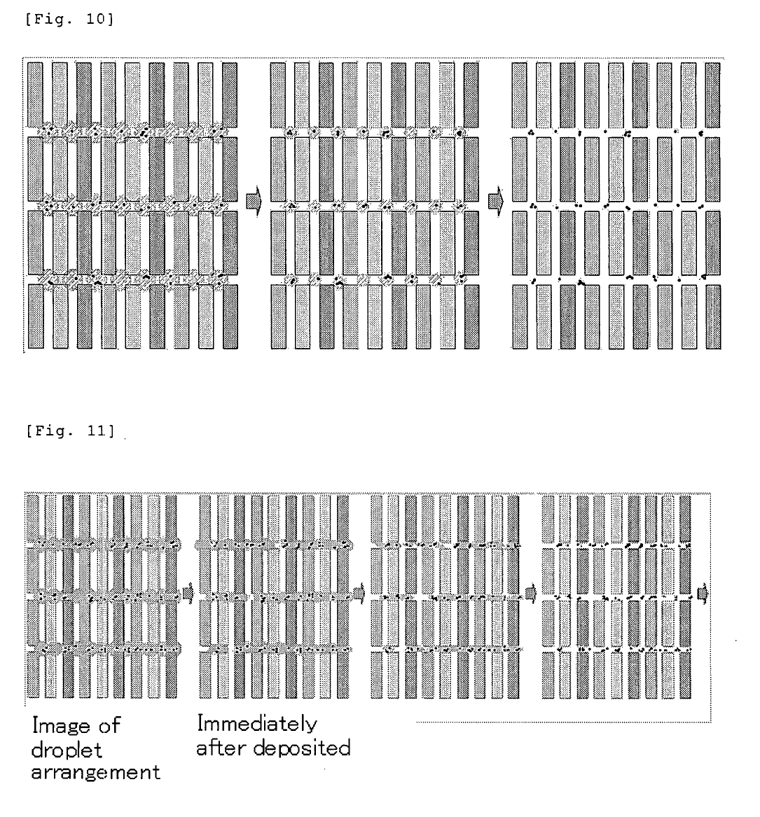

### EXPLANATION OF SYMBOLS

1 liquid crystal display device
2 first substrate
3 second substrate
4 color filter
5 black matrix
6 overcoat layer
7 transparent electrode
8 alignment layer
9 transparent electrode
10 alignment layer
11, 12 polarizer
13 sealing material
14 spacer particle
15 liquid crystal
21 spacer particle
22 meniscus
23 spacer particle dispersion
31 spacer particle
41 color filter substrate
42 glass substrate
43 black matrix
44 color filter
45 overcoat layer
46 transparent electrode
47 alignment layer
51 TFT array model substrate
52 glass substrate
53 step
54 transparent electrode
55 alignment layer
100 head.
101 ink chamber 1 (common ink chamber)
102 ink chamber 2 (pressure ink chamber)
103 ejecting face (nozzle face)
104 nozzle hole
105 temperature control means
106 piezo element

1. A method for producing a liquid crystal display device, having a pixel area and a non-pixel area,
which comprises a step of arranging a spacer particle at a specific location corresponding to the non-pixel area by ejecting a spacer particle dispersion with a spacer particle dispersed, onto a surface of a first substrate or a second substrate using an ink-jet device, and
a step of superimposing the first substrate on the second substrate via a liquid crystal and the spacer particle with the first substrate opposed to the second substrate,
in the step of arranging the spacer particle, a liquid-contacting portion of an ink chamber receiving the spacer particle dispersion in a head of the ink-jet device comprising a hydrophilic material having a surface tension of 31 mN/m or more, and a surface tension of the spacer particle dispersion being 33 mN/m or more and being not more than a surface tension of the liquid-contacting portion plus 2 mN/m.

2. A method for producing a liquid crystal display device, having a pixel area and a non-pixel area,
which comprises a step of arranging a spacer particle at a specific location corresponding to an area defining the pixel area by ejecting a spacer particle dispersion with a spacer particle dispersed, onto a surface of a first substrate or a second substrate using an ink-jet device, and
a step of superimposing the first substrate on the second substrate via a liquid crystal and the spacer particle with the first substrate opposed to the second substrate,
in the step of arranging the spacer particle at the specific location, a droplet of the spacer particle dispersion having a receding contact angle (θr) of 5 degree or more to the substrate and a water content contained in the spacer particle dispersion being 10% by weight or less.

3. A method for producing a liquid crystal display device, having a pixel area and a non-pixel area,
which comprises a step of arranging a spacer particle at a specific location corresponding to the non-pixel area by ejecting a spacer particle dispersion with a spacer particle dispersed, onto a surface of a first substrate or a second substrate using an ink-jet device, and
a step of superimposing the first substrate on the second substrate via a liquid crystal and the spacer particle with the first substrate opposed to the second substrate,
in the step of superimposing the first substrate on the second substrate via the liquid crystal and the spacer particle with the first substrate opposed to the second substrate, a rate of change of a volume resistivity of the liquid crystal being 1% or more and a change of a nematic-isotropic phase transition temperature of the liquid crystal being within ±1° C. from before to after arranging the liquid crystal.

4. The method for producing a liquid crystal display device according to claim 1, 2 or 3,
wherein a liquid-contacting portion of an ink chamber receiving the spacer particle dispersion in a head of the ink-jet device comprises a hydrophilic material having a surface tension of 40 mN/m or more.

5. The method for producing a liquid crystal display device according to claim 1, 2, 3 or 4,
wherein a material of a liquid-contacting portion of an ink chamber receiving the spacer particle dispersion in a head of the ink-jet device comprises at least one species selected from the group consisting of ceramic, glass and stainless steel.

6. A spacer particle dispersion,
which is used for the method for producing a liquid crystal display device according to claim 1, 2, 3, 4 or 5.

7. A spacer particle dispersion,
which is used when a spacer particle is arranged on a surface of a substrate using an ink-jet device,
a surface tension being 33 mN/m or more and being not more than a surface tension of a liquid-contacting portion of the ink chamber in a head of the ink-jet device plus 2 mN/m.

8. A spacer particle dispersion,
which is used when a spacer particle is arranged on a surface of a substrate using an ink-jet device,
a receding contact angle (θr) being 5 degree or more to the substrate and a water content being 10% by weight or less.

9. The spacer particle dispersion according to claim 8,
wherein a water content is 5 to 10% by weight.

10. A spacer particle dispersion,
which is used when a spacer particle is arranged on a surface of a substrate using an ink-jet device,
a rate of change of a volume resistivity of the liquid crystal being 1% or more and a change of a nematic-isotropic phase transition temperature of the liquid crystal being within ±1° C. in the case of the spacer particle obtained by drying the spacer particle dispersion being mixed with a liquid crystal.

11. The spacer particle dispersion according to claim 6, 7, 8, 9 or 10,
which contains a solvent having a surface tension of 38 mN/m or more and a boiling point of 150° C. or more and 250° C. or less.

12. A liquid crystal display device,
which is obtained by using the method for producing a liquid crystal display device according to claim 1, 2, 3, 4 or 5, or the spacer particle dispersion according to claim 6, 7, 8, 9, 10 or 11.
